(19) United States
(12) Patent Application Publication
(10) Pub. No.: US 2006/0272933 A1
(43) Pub. Date: Dec. 7, 2006

(54) Distillation methods and devices in particular for producing potable water

(76) Inventors: Jean-Paul Domen, Le Bois Tranche (FR); Stephane Viannay, Saint Aubin de Luigne (FR)

Correspondence Address: STATTLER, JOHANSEN, AND ADELI LLP, 1875 CENTURY PARK EAST SUITE 1360, LOS ANGELES, CA, 90067, US

(21) Appl. No.: 10/559,696

(22) PCT Filed: Jun. 3, 2004
(86) PCT No.: PCT/FR04/01373

§ 371 Date: May 11, 2006

(30) Foreign Application Priority Data
Jun. 6, 2003 (FR) 03/06838
Jun. 6, 2003 (FR) 0306838

(51) Int. Cl. C02F 1/04

(52) U.S. Cl. 203/10

(57) ABSTRACT

The inventive device is embodied in the form of a chamber-oven for diffusing vapour and saturated hot air which circulate in a closed circuit by natural convection. Said device is embodied in the form of a domestic-use solar energy collecting device provided with a greenhouse whose surface is equal to 1 m² and produces from 50 to 100 litres/day of distilled water. The device comprises a distillation unit arranged between two furnaces (59′, 79′) in a temperature-controlled container (48′). Said distillation unit comprises 100 flat thin hollow plates having a surface of 20 dm² by face and an active volume of 200 dm³. The fine and tensioned walls (54) of said plates are provided with a hydrophilic coating (60′) and internal (56′) and inter-plate (58′) spaces. The lower chimney (59′) comprises a greenhouse (118′, 119′) whose bottom is embodied in the form of an impermeable black layer provided with a thin hydrophilic carpet on the rear part thereof. Saturated hot air at a temperature of 80° C. enters inside (56′) hollow plates from bellow and exits from the top at a temperature of 50° C. A high chimney (79′) is provided with a monoblock heat exchanger (84′) which is transversed by a non-potable water to be distilled which, afterwards is spread warm (40° C.) over the hydrophilic coating (60′). During passage through the heat exchanger (84) the air is cooled to 30° C. and moved down by gravity to the inter-plate spaces (58′) and exits therefrom at a temperature of 78° C. The distilled water condensed in the plates and by the heat exchanger is collected and removed. Brine is received in the bottom of the inter-plate space and distributed along the thin hydrophilic carpet of the bottom (122′) of the greenhouse. An air current passes along said hot carpet is heated and saturated and enters the plates. The brine liquor finally flows in an air-preheating tank (63′) which is emptied each morning. The greenhouse can be substituted by a heating tube transversed by a heating fluid or associated with another steam-jet tube. The more powerful chamber-ovens can produce at least 200 m³/day of distilled water for collective consumption. Said invention can be used for salt removal from seawater, co-generating electricity and potable water and for producing food concentrates.

### BACKGROUND OF THE INVENTION

The present invention, resulting from the collaboration of Jean-Paul DOMEN and Stéphane VIANNAY, relates to improvements to a prior invention of the first-named, relating to distillation methods and devices, described in an international PCT Patent Application, filed by the applicant and published on 20th Dec. 2001 under No. WO 01/96244 A1. This PCT Application describes a general multiple-effect distillation method, intended to separate substances in solution from their liquid solvent, as well as two methods and particular stills.

These distillation methods and devices are chiefly intended for producing fresh water, easily transformable into potable water. They use low-temperature heat sources of various types (usual boiler, solar boiler or heat engine radiator) and treat most types of non-potable water, such as seawater, brackish groundwater or clear but polluted surface water. To this principal application are added those relating to the production of concentrates in various industries, in particular the food or chemical industries.

According to the general distillation method, the subject of this prior invention,

counter-current heat exchanges are carried out by a single heat-transfer fluid, liquid or gaseous, circulating in closed circuit along surfaces, hot S_{c} and cold surfaces S_{f} respectively, linked by significant thermal conductance;

said surfaces S_{c} and S_{f} are faces of walls of thin hollow distillation-heat-exchange plates, installed in large numbers, vertical or inclined, in a thermally insulated treatment chamber, comprising narrow inter-plate spaces, of a more or less constant width, filled with a non-condensable gas, in particular with air at atmospheric pressure;

the heat-transfer fluid circulates from the top downwards along the surfaces S_{c}, passing from a high initial temperature T₁ to a final temperature T₃ below T₁, then from the bottom upwards along the surfaces S_{f}, passing from an initial temperature T₄, below T₃, to a final temperature T₂, above T₄ and below T₁;

over the top of the external faces of the walls of the hollow plates, inside which the heat-transfer fluid circulates from the top downwards, liquid to be distilled is poured, which spreads out and runs down slowly in fine layers along these external faces;

under the action of the flow of heat-transfer fluid circulating from the top downwards along the surfaces S_{c}, some of the liquid to be distilled poured over said external faces evaporates, whilst this flow cools down, passing from T₁ to T₃, and the vapour produced diffuses in the non-condensable gas present in the inter-plate spaces;

under the action of the flow of heat-transfer fluid circulating from the bottom upwards along the surfaces S_{f}, the vapour diffused in the non-condensable gas condenses, whilst this flow heats up again, passing from T₄ to T₂, under the effect of recovery of a significant part of the latent heat of condensation of the diffused vapour;

a heat source is arranged between the hottest ends of the surfaces S_{c} and S_{f}, in order to increase the temperature of the heat-transfer fluid from T₂ to T₁;

a cold source is arranged between the least hot ends of these surfaces S_{c} and S_{f}, in order to reduce the temperature of the heat-transfer fluid from T₃ to T₄.

According to a particular first vapour-diffusion distillation method, derived from this general method:

the heat-transfer fluid is the liquid to be distilled;

the thin hollow distillation heat-exchange plates are hot or cold and they are installed alternating in the heat-insulated treatment chamber, their respective walls constituting said surfaces S_{c} and S_{f};

liquid to be distilled is poured over the top of the external faces of the walls of the hot plates only;

the heat-transfer liquid circulates from the top downwards inside the hot plates, it enters hot at temperature T₁ and it exits cooled down at temperature T₃, having caused partial evaporation of the liquid to be distilled flowing over the external faces of these plates;

at the outlet from the hot plates, the heat-transfer liquid undergoes an additional cooling down and passes to temperature T₄;

then, this heat-transfer liquid at temperature T₄ enters inside the cold plates where it circulates from the bottom upwards, on the one hand, causing, on the external faces of the walls of these cold plates, a condensation of the vapour diffused through the layer of non-condensable gas in the inter-plate space and, on the other hand, recovering part of the condensation heat of this vapour in order to heat up again and finally it exits from the cold plates at temperature T₂;

during these operations, the flows of heat pass through the walls of the hot and cold plates as well as the immobile layers of non-condensable gas which separate them;

the distilled liquid runs down along the external faces of the walls of the cold plates whilst the concentrated liquid runs down along the external faces of the walls of the hot plates.

According to a second particular distillation method derived from this general method:

the heat-transfer fluid is said non-condensable gas, saturated with vapour of the liquid to be distilled;

liquid to be distilled is poured over the top of the external faces of the walls of all the hollow distillation heat-exchange plates, these external faces constitute said cold surfaces S_{f}, whilst the internal faces of the walls of these plates constitute said hot surfaces S_{c};

the flow of gas at temperature T₁ enters inside all the hollow plates where it circulates from the top downwards, whilst part of its vapour condenses on the internal faces of the walls of the plates, and flows of heat, resulting from a partial recovery of the condensation heat, pass through the walls of the plates in order to evaporate some of the liquid flowing over their external faces and, consequently, this flow of gas cools down and exits from the hollow plates at temperature T₃;

at the outlet from these hollow plates, the flow of gas at temperature T₃ undergoes additional cooling and passes to temperature T₄;

then this flow of gas at temperature T₄ enters the inter-plate spaces where it circulates from the bottom upwards, carrying along the vapour produced in these spaces and heating up again, and finally it exits from these spaces at temperature T₂;

the distilled liquid runs down along the internal faces of the walls of the hollow plates whilst the concentrated liquid runs down along their external faces.

For the implementation of these distillation methods, thin and hollow heat-exchange elements, made of polymer (in particular of polypropylene), are described in this PCT Application. These elements are thin, hollow, rectangular plates, of large dimensions (generally from 50 to 150 dm²), with walls provided with a welded and/or glued hydrophilic or wettable coating. They are of two main types: (1) flexible panels, with very fine corrugated walls (0.15 mm in thickness), forming narrow ducts (15 mm), separated by parallel weld lines, and (2) rigid cellular panels, with fine plane walls (0.3 mm in thickness). These two types of thin hollow plates are carried by a flat rod, resting on uprights.

These distillation methods, referenced hereafter by their author's initials JPD, are clearly differentiated from that implemented in the solar still, described in the European patent EP 1 312 404 A1, published on 21st May 2003 and referenced hereafter by its inventor's initials AVP. This AVP solar still comprises, in a treatment chamber, an evaporator and a condenser arranged vertically, and outside, a solar boiler, a radiator and a pump. The external wall of the evaporator is constantly dampened by seawater poured over its upper edge. Under the pump action, a heat-transfer liquid circulates in closed circuit from the bottom of the boiler upwards, from the top of the evaporator downwards, from the bottom of the radiator upwards and from the bottom of the condenser upwards, to finally arrive at the bottom of the boiler. The radiator is a unit for cooling down the heat-transfer liquid, subjected to the action of a flow of air. The seawater poured over the evaporator, heated by the heat-transfer liquid which exits from the boiler, evaporates in part and, consequently, the air which surrounds it heats up again and is saturated. By natural convection, this saturated hot air rises along the walls of the evaporator, begins to circulate in closed circuit in the treatment chamber and, during its passage, passes the zone occupied by the condenser from the top downwards. The heat-transfer liquid, which is cooled down while passing through the evaporator, undergoes an additional cooling down while passing through the radiator. As a consequence, it arrives at the bottom of the condenser at a temperature lower than that which it had when exiting from the evaporator. The particular structure given to the condenser (see FIG. 3) results in the flow of saturated hot air and the flow of cooled down heat-transfer liquid circulating in crossed circuits. The vapour contained in the air condenses on the relatively cold walls of the condenser and the latent heat of condensation is recovered by the heat-transfer liquid, thus reducing the thermal energy required at the solar boiler. The distilled water and the salt water are recovered in tanks installed under the condenser and under the evaporator respectively.

By comparison of the JPD and AVP distillation methods, described above, it is seen that, in spite of the common concepts, already set out in another JPD document, the publication WO 98/16474 A1, cited as prior art in the PCT Application referred to above, fundamental differences appear which clearly distinguish one from the other. In the JPD method, a single liquid or gaseous heat-transfer fluid is used and, in the AVP method, two fluids, liquid and gaseous respectively, are used simultaneously. Moreover, in the JPD method, the evaporator and the condenser are thin hollow plates, with fine walls, juxtaposed with narrow inter-plate spaces filled with air, in order to constitute heat-exchange surfaces, linked together by significant thermal conductance. In the AVP method, the evaporator and condenser units both have complex forms and, moreover, are different and relatively distant from each other. This scarcely makes it possible to establish a significant thermal conductance between them. When, in the JPD method, the heat-transfer fluid is a liquid, the thin hollow plates are alternately hot and cold and the hot and cold flows concerned circulate a very small distance from each other and in opposite directions (and not in crossed directions), whilst the thin layer of air which separates these plates remains immobile. This allows particularly efficient heat exchanges which are at the origin of the sought high productivity of distillation. When in the JPD method, the heat-transfer fluid is saturated hot air, the internal and external faces of the fine walls of the thin hollow plates constitute heat-exchange surfaces, linked by maximum thermal conductance, which, is evidently not to be found in the AVP method. Moreover, the JPD method can be the subject of mathematical modelling, really representative of the phenomena concerned, which alone makes it possible to understand and therefore to optimize these phenomena, since the elements to be taken into account have a simple geometry and well-defined arrangements in space. This scarcely appears to be possible with the elements of the AVP solar still, which have complex geometries and very weak and poorly-defined thermal conductance connections.

In the publication WO 01/96244 A1 referred to above, on page 21, lines 2 to 7 it says: “The maximization of the performance coefficient of a distillation device the parameters of which are fixed ( . . . ), requires the difference in temperature between the flows of hot and less hot water exiting from the boiler and entering it, to be as small as possible, whilst the difference in temperatures between the top and bottom of the heat-exchange elements must by contrast, be as great as possible”.

Such a statement is correct in certain cases, but as will be seen below, its generalization leads to conclusions which are simplistic and incomplete in certain cases and even false in other cases. By way of example, it will now be noted that the Performance Coefficient C_{OP} of a heat-exchange or distillation device, i.e. the ratio between the exchanged thermal power Q and the power P, provided by the boiler, also determines the cost price of the exchanged energy and/or of the distilled water, using two other parameters, namely, (1) the cost of the energy used, which is inversely proportional to the performance coefficient C_{OP}, and (2) the amortization of the price of the device, which is itself proportional to the C_{OP}, as will be demonstrated hereafter.

In a standard counter-current heat exchanger, between two fluids with a constant heat capacity Cₚ, the temperature of the heat-transfer fluid at the outlet from the boiler or at the inlet to the hot surfaces of the exchanger will hereafter be designated T₁, the temperature of the fluid at the outlet from the cold surfaces T₂, the temperature of the heat-transfer fluid at the outlet from the hot surfaces T₃, and the temperature of the fluid at the inlet to the cold surfaces of the exchanger T₄. And the difference in temperature which exists on both sides of the hot and cold surfaces concerned will be designated dT. Ignoring the heat losses from the exchanger, the two differences in temperature (T₃−T₄) and (T₁−T₂) are generally both equal to dT.

It will be noted that such heat exchangers can only operate within a temperature range imposed by the behaviour of the materials used at high and low temperatures, and by the various change-of-state temperatures of the fluids concerned. Consequently, there is a maximum value imposed for the difference (T₁−T₃). And it is for this maximum value that the exchanged power Q will also take on its maximum value.

The exchanged power Q is expressed in two ways, depending on whether the heat-transfer fluid or the heat exchanger are considered. In the first case, this gives Q=Cₚ.D.(T₁−T₃), with Cₚ being the heat capacity at constant pressure of the heat-transfer fluid, (in the case of water, Cₚ=4.19 joules, per gram and per degree), and D, the circulating mass flow rate. In the second case, we have the equation Q=k.V.dT, with k being the volume thermal conductance of a heat exchanger, and V the active volume of this exchanger. The volume thermal conductance k of a heat exchanger is defined as being the thermal power in Watts, transmitted through an exchanger with one cubic metre of active volume, in response to a difference in temperature of one Kelvin. The dimension of the term k is therefore W/m³.K.

In the case of a standard counter-current heat exchanger, it is known that the performance coefficient C_{OP}=(T₁−T₃)/dT. In the case of a vapour-diffusion still with a counter-current of water, the heat-transfer liquid circulates in closed circuit, this liquid enters the boiler at temperature T₂ and exits from it at T₁, so that the power supplied by the boiler is P=Cp.D.dT, As regards the gross performance coefficient of the counter-current exchanger, constituted by this still, i.e. with the ratio Q/P, its value is also C_{OP}=(T₁−T₃)/dT.

If we now concern ourselves with the product of C_{OP} by Q, the exchanged thermal power, we find that the value of the quantity C_{OP}.Q characterizes the practical performances of a heat exchanger, which is the more efficient, the larger this quantity. If, moreover, this same quantity is divided by the active volume V of the exchanger, it is then possible to compare two heat exchangers of different volumes and define their Intrinsic Efficiency Criterion, which is defined by the term C_{IE}=C_{OP}.Q/V=Q²/P.V=k.(T₁−T₃).

For a standard counter-current heat exchanger, the volume thermal conductance k of the exchanger and the heat capacity Cₚ of the liquids concerned have constant values, independent of the temperature T and of difference dT. Consequently, the term C_{IE} passes through a maximum when C_{OP} and Q are themselves maximum, i.e. for the extreme values, high and low respectively, imposed for T₁ and T₃, according to the statement referred to above. But this is not at all the case for the distillation heat exchanges which occur in vapour-diffusion stills.

In fact, in vapour-diffusion distillation heat exchangers, such as the stills according to the prior invention, the volume thermal conductance of the exchanger varies considerably within the theoretical temperature range that the device could explore, i.e. from 20 to 30° C., a range of the possible low limits of the cold source, constituted by the cold liquid to be distilled entering the still, up to a value at the most equal to the boiling temperature of this same liquid. This results from the quasi-exponential character of the partial vapour pressure, expressed as a function of temperature. Consequently, in the case of a vapour-diffusion still with counter-current of water, the Intrinsic Efficiency Criterion of this still C_{IE}, does not show its maximum for the possible low limit of T₃.

In order to be able to make a first improvement to the distillation methods referred to above, in order to determine then obtain the optimum value of the temperature T₃, at the outlet from hollow rectangular heat-exchange plates, which are flexible (crescent-shaped cells, corrugated wall) or rigid (rectangular cells, plane wall), described in the PCT Application referred to above, it is first necessary to establish the quantitative theory of the vapour-diffusion stills. This is in order to work out the fundamental physical laws which govern them. In order to do this, a systematic logic analysis will first be made of the operation of a vapour-diffusion still with counter-current of water.

To this end, for such a still using seawater as heat-transfer fluid, the two types of parameters concerned will be defined, namely, those of construction (fixed on leaving the factory) and those of use, which determine their operation.

The construction parameters are the following:

(e), the average internal thickness of the hollow plates and of the water in these plates,

(a), the average thickness of the layer of air between the plates,

(2p), the pitch of plates of same kind, hot or cold,

(h), the height of the plates,

(N) the number, and (I) the width of the plates,

(V), the active volume of the exchanger with V=p.N.l.h,

the thickness, the thermal conductivity and the form (plane or corrugated) of the walls of the hollow plates.

The use parameters are at the user's disposal and are the following:

(D), the flow rate and (v), the velocity of the water in the hollow plates,

(t), the transit time of the water in these plates, with t=h/v and D=V.e/2p.t,

(dT), the difference in temperature between the fluids circulating in the hot and cold plates,

(P), the thermal power of the boiler,

(Q), the thermal power exchanged by distillation, expressed as m³/day of distilled water, each unit corresponding to approximately 27 kW;

the range of temperature of use in the hot hollow plates, with T₁ at the inlet and T₃ at the outlet.

Given the two expressions referred to above, which define the thermal power exchanged between the hot and cold surfaces concerned, namely that Q=Cₚ.(T₁−T₃).D, provided by the heat-transfer fluid and Q=k.V.dT, transmitted by the exchanger, the following equation is deduced: t.dT=Cp.(T₁−T₃).e/k, which means that this term t.dT takes on a determined value as soon as T₁, T₃ and k are themselves determined. It results from this that the thickness of water e and that of air a being fixed by the constructor, the values at the user's disposal, namely, the transit time (t) and the difference in temperatures dT vary in reverse directions, as soon as their product has a chosen determined value. Consequently, the term t.dT appears to be a composite variable, a function both of certain construction parameters, of the extreme temperatures T₁ and T₃ and of all the intermediate T values. Therefore t.dT must be considered as the determinant independent variable, to be taken into account for calculating the temperature of the heat-transfer fluid as it runs down along the whole length of the hot heat-exchange surfaces.

On the basis of these fundamental physical equations which govern the operation of the vapour-diffusion stills with counter-current of water, according to said prior invention, it becomes possible to optimize this operation. In order to do this, a software package has been produced making it possible to model the transfers of mass and heat which are produced along the whole length of the hollow plates of these stills. In the first case studied, the heat-transfer liquid circulates from the top downwards in the hot plates and the interface between the heat-transfer liquids rising and running down is then the external face of the walls of the cold condensation plates. The plates are made of polymer (polypropylene in particular) and their thermal conductivity is 0.2 W/m.K. The calculation relates to the temperatures which appear from the top of the hot surfaces of these plates downwards, as a function of all the parameters concerned, namely the temperature T₁, the construction and use parameters and the thermal conductances referred to above. This calculation is carried out step by step in order to work out the temperature curves of the portions of heat-transfer fluid, as a function of their height h, measured from the top of the hot hollow plates downwards, i.e. curves T=f (h) corresponding to the maximum natural value of T₁ and a possible minimum natural value (without artificial cooling) of T₃ for different values chosen from the construction parameters e and a.

With seawater as heat-transfer fluid, at a constant heat capacity Cp, the curve of the temperature T=f (h) and that of C_{IE}=g(h), will now be calculated, section by section, along the whole length of the hot surfaces, using the software concerned, for rigid cellular plates with plane faces, having a total wall and coating thickness of 0.5 mm, an internal thickness e=3 mm and a pitch p=8.5 mm. These three dimensions are the minimum values that it has been possible to give to the experimental prototypes, in order to ensure that the hot and cold plates can never touch each other.

The curve A₁ shown in FIG. 1 hereafter T=f(h) was calculated for plane hot plates, with T₁ approximately 100° C., a plate height h=100 cm, a plate pitch p=8.5 mm, with an internal thickness of water e=3 mm, an air-layer thickness a=5 mm and a total thickness of walls and hydrophilic coatings of 0.5 mm, a water-circulation velocity v=0.5 mm/s and a difference in temperature dT=5.5 K. The axis of the composite variable t.dT=dT.h/v has been drawn parallel to the h axis.

For the value T=32° C., which corresponds to a height h=100 cm, the transit time t=2.000 s and the composite variable t.dT=11,000 K.s. For any intermediate value of T between 32 and 100° C., the corresponding value of t.dT is immediately deduced.

In this same FIG. 1 the curve B₁ is also drawn, which represents the variation in the Intrinsic Efficiency Criterion of distillation of the still C_{IE}=C_{OP}.QN=Q²/P.V, as a function of the composite variable t.dT (deduced from h), which is linked to V, the active volume, by the equation specified above V=p.N.l.h. This criterion C_{IE} is representative of the product of the C_{OP} by Q/V, the volume in cubic metres of distilled water per day and per cubic metre of active volume of still. In the present case, the range of the possible variations of this criterion is established from 0 to 18. The curve B₁ shows a maximum C_{IE}=17.8 for t.dT=3000 K.s, and gives T₃=68.5° C. when T₁=100° C. According to FIG. 1, the ranges of optimum values of t.dT and T₃ are defined by the curve A₁ and that of C_{IE} by its maximum (C_{IE}>17), i.e. 1900<t.dT<4450 K.s and 58<T₃<78° C. These ranges of optimum values vary little when the e/p ratio remains constant, the maximum of C_{IE} itself being highest when the parameters e and p have their minimum values. Consequently, for any C_{IE}>17 and any particular value of the composite variable t.dT, situated within the optimum range which follows from the latter, the operation of a vapour-diffusion and heat-transfer-liquid still will be optimized as soon as one of the parameters t or dT has been chosen and T₃ deduced from this choice.

As C_{OP}=Q/P, this term is also inversely proportional to the cost of the energy used. As regards the ratio Q/N, this is inversely proportional to the active volume V and therefore to the number of plates installed in order to obtain a determined daily production Q. As Q/V can also be written=C_{IE}/C_{OP}, when the price of energy at the operating site is high (fossil fuels or electricity), a high value will be chosen for C_{OP}. And, in the case where this energy is inexpensive (solar or co-generation from the cooling liquid or exhaust gas from heat engines), a lower C_{OP} will be chosen and therefore a limited investment (fewer heat-exchange plates). It will be noted that these variations in reverse directions make it possible to obtain maximum efficiency when the price of the energy is equal to the amortization of the investment relative to the total volume of distilled water, produced over the duration of this amortization.

When flexible plates with corrugated walls, composed of parallel ducts, crescent-shaped in cross-section, are used, the two curves A₁ and B₁ in FIG. 1 are a little different: the curve A₁ which represents T=f(h), has more or less the same shape but the curve B₁, C_{IE}=f (t.dT), has a clearly less pronounced maximum with a value of approximately 9 instead of 18. Comparable results are obtained for the two types of hollow plates (rigid and plane or flexible and corrugated), when the temperature T₁ is appreciably below the optimum temperature indicated above (100° C.), i.e. 85° C. for example.

In a second case studied, the direction of circulation of the heat-transfer liquid taken into account in the preceding calculation (from the bottom upwards instead of from the top downwards, in the hot plates) was reversed whilst keeping the hollow hot and cold plates considered unchanged. The results obtained in this second case are scarcely different from those obtained in the first.

It will be noted that in the case of the stills with counter-current of water, implementing these two distillation methods according to the invention, the interface, through which the transfers of heat take place between the two flows of water which circulate in reverse directions, is situated in the wall which separates the rising flow of water from the liquid trickling down, which is distilled water in the first case studied (circulation of the heat-transfer liquid from the top downwards in the hot plates) and salt water in the second case (circulation in the reverse direction).

We shall now consider the vapour-diffusion distillation method with a heat-transfer gas (air), saturated with vapour. The construction and use parameters, referred to above for a distillation method with a counter-current of water, are again taken up in the present case. On the other hand, with the apparent heat capacity Cₚ of the air saturated with vapour increasing hugely as a function of temperature, the difference in temperature between the internal and external faces of the plates must vary in the reverse direction. Under these conditions, if it is simple, for a vapour-diffusion still with counter-current of water, to express the difference in thermal power applied between the heat-exchange surfaces, as a function of dT alone, since Cₚ is then constant, in the case of a vapour-diffusion still with counter-current of air, it becomes necessary to return to the thermal power applied between the internal and external faces of the hollow distillation plates.

According to the invention, this difference in thermal power is expressed by the local difference in enthalpy flows (in Watts) between the flows of saturated air along the hot external faces S_{c} and cold internal faces S_{f} of these hollow plates. These enthalpy flows are defined at two opposite levels of the faces of a wall of plates, by H_{c}=D.C_{pc}.T_{c}, for the face S_{c}, and by H_{f}=D.C_{pf}.T_{f}, for the face S_{f}. A local difference in enthalpy flows is defined by dH=D.(C_{pc}.T_{c}−C_{pf}.T_{f}). In these expressions, C_{pc} and C_{pf} are the apparent heat capacities of the flows at temperatures T_{c} and T_{f}, existing at two opposite levels. The term Cₚ=δH/D.δT, with on the one hand, δH and δT, conjugated elementary variations in enthalpy flows H and temperature T and, on the other hand, D, the flow rate of dry air and Cₚ, the apparent heat capacity of the saturated hot air, at any temperature T, expressed in degrees Kelvin. In this regard, it will be recalled that the heat capacity Cₚ of the dry air has a constant value of 1000 joules per degree and per kilogram but that, on the other hand, the apparent heat capacity Cₚ of the hot air saturated with vapour is 740 kJ/K/kg of dry air, between 91 and 92° C., and only 16.4 kJ/K/kg of dry air, on average between 24 and 45° C.

It will be noted that, in the case of a still with counter-current of air circulating opposite the natural convection, the interface through which the transfers of heat take place between the upward and downward flows is the free surface of the salt water. On the other hand, in the case of a still with a counter-current of air circulating by natural convection, this interface is the free surface of the distilled water.

On the basis of these basic findings, relating to a vapour-diffusion still with counter-current of air, a second software package has been developed which makes it possible to calculate the temperature profiles along the internal and external walls of hollow plates with plane faces of polymer. Starting with the temperatures at the top of the plates, with a value t.dH/V=2400 kJ/m³ and values T₁=92° C. and T₂=91° C., (which corresponds to a given local difference in enthalpy flows with a value dH₁), and adopting a dry air circulation velocity v₁ of 10 cm/s (which, by way of example, gives v=20 or 40 cm/s for humid air with 50% or 75% partial vapour pressure), the calculation was made for a temperature T₄, at the bottom of the inter-plate spaces, compatible with that of the available natural cold sources (20 to 30° C., for example). The curve A₂ represents the function T=f₁(h) along the hot internal faces of the hollow plates and the curve C₂ represents the function T=f₂(h) along their cold external faces. As regards this curve C₂, it will be noted that no curve C, appears in FIG. 1, since it could be deduced from the curve A₁, by a simple constant shift dT (except for losses). On the other hand in FIG. 2, this curve C₂ is clearly differentiated from the curve A2 since the increasing difference in degrees (° C.), which separate them from each other at each decreasing level h, expresses the constant local difference in enthalpy flows dH₁, which corresponds to the values of T₁ and T₂, expressed above. With T₁ reduced to 91.5° C. and T₂ maintained at 91° C., the curve C₂ would remain unchanged and the curve A₃ obtained would be situated at an almost equal distance from the curves A₂ and C₂ represented.

With T₁ maintained at 92° C. and T₂ reduced to 90° C., the curve A₂ would remain unchanged and the curve C₃ obtained would be deduced from the curves A₂ and C₂ represented by a shift at each level, almost double that of these two curves represented. It will be noted that these comments apply without correction to pure water, which is the subject of a distillation, but not at all to salt water. In fact, for two types of seawater, with 35 or 70 grams of sodium chloride per litre, the boiling temperatures are 100.5° C. and 101° C. respectively. This means that for these types of water, during a distillation operation, a difference in temperature of approximately 0.5° C. or 1° C. is used up by the operation of desalination of these types of water and therefore neutralized for their distillation.

As regards the curves A₁ in FIG. 1 (counter-current of water) and A₂ in FIG. 2 (counter-current of air), it will be noted that the curve A₂, unlike A₁, shows very significant concavity, directed towards the top of the plates. This means that the heat exchanges by vapour diffusion, in the case of a still with counter-current of air, are much greater towards the low temperatures than towards the high. Under these conditions, the maximum C_{IE} has been sought starting from the low temperatures. In this zone in fact, the flows of heat which pass through the walls of the hollow plates, between the opposite portions of the two fluids circulating in reverse directions, are much greater for the same difference in enthalpy flows, because of the greater difference in temperature to which this local difference in enthalpy flows corresponds.

The curve B₂ in FIG. 2 represents the evolution of C_{IE} as a function of the composite variable t.dH/V (in kilojoules per m³) to be retained in the case of a still with a counter-current of air. This evolution is not very sensitive to the difference (T₁−T₂) and therefore to the value of the local difference in enthalpy flows dH₁ referred to above, which served to calculate this curve B₂. The maximum C_{IE} corresponds, on the curve A₂, to a temperature T₁ of approximately 85° C., at the inlet to the hollow plates and, for the local difference dH₁ retained, the value of T₂ read on the curve C₂ is approximately 80° C., at the outlet from the inter-plate spaces. The value of T₁, at the inlet to the hollow plates, is determined by the maximum temperature of the available heat source and the value of T₄ at the inlet to the inter-plate spaces, by the minimum temperature of the available natural cold source. In the case where this cold source is the liquid to be distilled entering at 25° C., it is possible, by means of an appropriate heat exchanger, to have a value T₄ of 30° C. In this case, with the conditions referred to above (dH₁ and v₁), we have T₃=68° C. With a higher value T₄, the value of T₃ increases and, in this case, the maximum C_{IE} is less high and it is obtained for a greater value t.dH/V. Similarly, for a local difference dH greater or smaller than the value dH₁ referred to above, if a value as low as possible (30° C., for example) is kept for T₄, there will be a maximum C_{IE} varying in the reverse direction, i.e. a little less high or a little higher than previously, provided that the composite variable t.dH/V varies like dH.

In FIG. 2, the Intrinsic Efficiency Coefficient of the C_{IE} still, defined by C_{OP}.Q/V or Q²/P.V or also k.(T₁−T₃), shows a maximum of 95 m³ of fresh water per day and per active m³ of still, for a value of the composite variable t.dH/V of 382 kilojoules/m³. The optimum C_{IE} value is greater than 84, which corresponds to 210<t.dH/V<740 kJ/m³ and an optimum range 78<T₁<91° C. In practice however, it is clear that any C_{IE} value greater than one-third, for example, of its maximum possible value (which is of the order of 100, for the hollow plates, with the characteristics defined hereafter, adopted for the calculation) is completely welcome. This means that as soon as T₄ has been able to take on a very low value (down to 10° C., for example, if it has been possible to cool down the liquid to be distilled entering, by economic natural means), all values of T₁ defined by the temperature range 74° C.<T₁<91° C. and, in the case of the results of the study shown in FIG. 2, all the values of the composite variable t.dH/V which are defined by the range 100 kJ/m³<t.dH/V<1300 kJ/m³, make it possible to construct a vapour diffusion and heat-transfer gas still with high productivity.

The preceding results were obtained for thin hollow plates with plane walls, which have an internal thickness e=2 mm, an identical inter-plate space, a wall and hydrophilic coating thickness of 0.6 mm and therefore a pitch p=5.2 mm. The ranges of optimum values defined above vary little when the e/p ratio remains more or less constant, the maximum C_{IE} being highest when the parameters e, a and p have their minimum values, imposed by practical considerations. These considerations are aimed at ensuring that the losses of charge in the inter-plate spaces are always acceptable, which limits to 2 mm the minimum internal thicknesses e and a of the hollow plates and of their inter-plate spaces. On the other hand, if this value of e is retained and a new model of hollow plates with particularly thin plane walls (0.15 mm total thickness of wall and hydrophilic coating) is created, results much better than those illustrated by the curves in FIG. 2 are obtained. Such a hollow distillation-heat-exchange plate is described hereafter in FIG. 13. With this new model of plates, the maximum C_{IE} calculated is considerably increased (297 m³/day, per m³ of active volume, instead of 95), if we take e=2 mm and p=4.5 mm. With an internal thickness e=3 mm, an identical inter-plate space and a pitch p=6, 5 mm, this maximum drops to 132. As regards the curves A₂-C₂ and the optimum (or simply efficient, because they provide completely satisfactory results) values of the temperatures T₁, T₂, T₃ and T₄, they remain almost the same.

If the direction of circulation of the heat-transfer gas taken into account in the preceding calculation is reversed, by causing this gas to circulate from the bottom upwards (and no longer from the top downwards) in the hollow plates and from the top downwards (and no longer from the bottom upwards) in the inter-plate spaces, more or less identical results are obtained.

These results demonstrate the exceptional usefulness presented by the stills with vapour diffusion and counter-current of air and since, within the framework of the limits of the technology currently available, they can easily display CEs comprised between 30 and 100, whereas the stills with a counter-current of water display C_{IE}s of 18 at the most.

### SUMMARY OF THE INVENTION

The first subject of the present invention relates to improvements and extensions, capable of being made to the general distillation method, with liquid or gaseous heat-transfer fluid and vapour diffusion in a non-condensable gas, described in said prior invention, which follow from the physical laws governing the functions of the stills implementing this general method.

The second subject of the invention relates to two types of improvements, resulting from the physical laws in question, capable of being made to the particular vapour-diffusion distillation methods and devices, in which the heat-transfer fluid is the liquid to be distilled, and the direction of circulation of this liquid that described in said prior Application or the reverse direction.

The third subject of the invention relates to two other types of improvements, resulting from the physical laws in question, capable of being made to the particular vapour-diffusion distillation methods and devices, in which the heat-transfer fluid is the non-condensable gas, saturated with vapour of the liquid to be distilled, and the direction of circulation of this gas, that described in said prior Application or the reverse direction.

The fourth subject of the invention relates to vapour-diffusion stills, in which the simple heat exchangers used have a new, compact, low-cost architecture.

The fifth subject of the invention relates to a distillation heat exchanger, comprising a monobloc active element, suited to the requirements of a vapour diffusion and heat-transfer-gas still.

The sixth subject of the invention relates to means of completely safely connecting large thin hollow distillation-heat-exchange plates to their heat-transfer fluid inlet and outlet ducts.

The seventh subject of the invention relates to means of pouring the liquid to be distilled over the external faces of the walls of distillation-heat-exchange hollow plates efficiently and completely safely.

The eighth subject of the invention relates to new, thin and flexible hollow distillation plates with very fine plane walls, which can be used in vapour-diffusion and heat-transfer gas stills;

The ninth subject of the invention relates to hot sources especially suited to the particular requirements of certain of the distillation devices referred to above.

According to an improvement to said prior invention, a general multiple-effect distillation method, intended for separating substances in solution from their liquid solvent, in particular for producing fresh water or concentrates, in which:

counter-current heat exchanges are carried out by a single liquid or gaseous heat-transfer fluid, circulating in closed circuit along surfaces, hot S_{c} and cold S_{f} respectively, linked by significant thermal conductance;

said surfaces S_{c} and S_{f} are faces of walls of thin distillation-heat-exchange hollow plates, installed in large numbers, vertical or inclined, in a heat-insulated treatment chamber, comprising narrow inter-plate spaces, of more or less constant width, filled with a non-condensable gas, in particular air at atmospheric pressure;

is characterized in that:

the heat-transfer fluid circulates, in a first upward or downward direction, along the hot surfaces S_{c}, passing from a high initial temperature T₁ to a final temperature T₃ below T₁ then, in a second direction opposite the first, along the cold surfaces S_{f}, passing from an initial temperature T₄, below T₃, to a final temperature T₂, above T₄ and below T₁;

at the top of the external faces of the walls of the hollow distillation plates, inside which the heat-transfer fluid circulates in said first direction, liquid to be distilled is poured which spreads out and runs down slowly in fine layers along these external faces;

under the action of the flow of heat-transfer fluid circulating in said first direction, some of the liquid to be distilled poured over said external faces evaporates, whilst this flow cools down, passing from T₁ to T₃, and the vapour produced diffuses in the non-condensable gas present in the inter-plate spaces;

under the action of the flow of heat-transfer fluid circulating in said second direction, the vapour diffused in the non-condensable gas condenses, whilst this flow heats up again, passing from T₄ to T₂, under the effect of a virtually total recovery of the latent heat of condensation of the diffused vapour;

a heat source is arranged between the hottest ends of the surfaces S_{c} and S_{f}, in order to increase the temperature of the heat-transfer fluid from T₂ to T₁;

a cold source is arranged between the least hot ends of these surfaces S_{c} and S_{f}, in order to reduce the temperature of the heat-transfer fluid from T₃ to T₄;

a more or less constant local difference dH in enthalpy flows is established between the surfaces S_{c} and S_{f}, by giving appropriate amplitudes to the heat exchanges carried out between the flow of heat-transfer fluid and said hot and cold sources respectively;

the optimum temperatures of the heat-transfer fluid T₁, T₂ and T₃, T₄, at the ends of these same surfaces, are determined from the maximum Intrinsic Efficiency Criterion C_{IE}=Q²/P.V of the installation, Q being the exchanged distillation thermal power, P being the thermal power provided by the heat source, and V the active volume of the installation.

Thanks to these arrangements, the general distillation method, using a single liquid or gaseous heat-transfer fluid, described in said prior invention, is both extended and optimized. Firstly, two new types of stills are added to the two prior types, previously described. This is done by using identical or equivalent components and giving two possibilities instead of only one, to the direction of circulation of one or other of the two heat-transfer fluids provided. Then, by application of the conclusions of the mathematical modelling of the particular heat-exchange phenomena existing in the vapour-diffusion stills according to said prior invention, the relative and absolute thermal characteristics, namely the constant local difference in enthalpy flows between the surfaces S_{c} and S_{f} and the temperatures of the heat-transfer fluid at the inlets to and outlets from the thin hollow plates and/or of their spacings are fixed. Thanks to which, the efficiency of the distillation carried out can be understood, controlled and thus maximized.

According to the invention, a first particular vapour-diffusion distillation method, in particular for producing fresh water, according to the improved general method defined above, in which:

the heat-transfer fluid is the liquid to be distilled;

the thin, hollow distillation-heat-exchange plates are hot or cold and they are installed alternating in the heat-insulated treatment chamber, the internal faces of their respective walls constituting said hot S_{c} and cold surfaces S_{f};

liquid to be distilled is poured over the external faces of the walls of the hot plates only;

is characterized in that:

the heat-transfer liquid circulates, in a first upward or downward direction, inside the hot plates, it enters very hot at temperature T₁ and it exits cooled down to the temperature T₃, having caused a partial evaporation of the liquid to be distilled flowing over the external faces of the walls of these hot plates;

at the outlet from these hot plates, the heat-transfer liquid at temperature T₃ is cooled down to temperature T₄;

then, the heat-transfer liquid at temperature T₄ enters inside the cold hollow plates where it circulates in a second direction, opposite the first, causing, on the external faces of the walls of these cold plates, a condensation of the vapour diffused through the layer of non-condensable gas in the inter-plate space and recovering virtually all of the condensation heat from this vapour in order to be heated up again, and finally it exits from the cold plates at temperature T₂;

during these operations, the flow of heat passes through the walls of the hot and cold hollow plates as well as the immobile layers of non-condensable gas which separate them;

the distilled liquid runs down along the external faces of the walls of the cold plates whilst the concentrated liquid runs down along the external faces of the walls of the hot plates;

the optimum temperature T₁ of the heat-transfer liquid, at the inlet to the hot hollow plates, is as little as possible below the boiling temperature of this liquid at atmospheric pressure;

the optimum temperature T₃ of the heat-transfer liquid, at the outlet from the hot hollow plates, is relatively high and situated in a range which corresponds to a zone surrounding the maximum Intrinsic Efficiency Criterion C_{IE} of the installation;

the differences in temperature (T₁−T₁) and (T₃−T₄) are small, with (T₁−T₂) being slightly greater than (T₃−T₄).

According to additional characteristics of this vapour-diffusion and heat-transfer-liquid distillation method,

the correspondence between the optimum range of the temperatures T₃ and the maximum C_{IE}, is achieved by means of their respective relationships with a composite variable t.dT, in which t is the transit time of the heat-transfer liquid in the plates and dT the difference in temperature between the liquids circulating in the cold and hot hollow plates;

the useful range of the temperature T₃ is the range from 58 to 78° C., when the liquid to be distilled is water;

the optimum difference in temperature dT is established by an adjustment of the ratio between the heating power of the heat source and the mass flow rate D of circulating heat-transfer liquid;

the optimum value chosen for dT is relatively high when the unit cost of the thermal energy easily available at the site of implementation of the method, is relatively low;

the optimum transit time t of the heat-transfer fluid in the heat-exchange plates is established by adjustment of the mass flow rate D of the heat-transfer liquid circulating in a closed loop.

Thanks to these arrangements, the distillation method with vapour diffusion and heat-transfer liquid becomes a really efficient method, using new stages which are particularly simple to implement, applying the conclusions of the mathematical modelling of the phenomena concerned. These stages consist of increasing in particular the temperature of the liquid to be distilled entering the installation, before mixing it with the liquid to be distilled circulating in a closed loop, by a simple heat exchange with the distilled and concentrated liquids, exiting from the installation at a high average temperature, of approximately T₃. This value T₃ is particularly high (58 to 78° C.), applying said conclusions, because of the maximum temperature T₁ (100° C.) of the liquid exiting from the boiler and appropriate adjustment of the transit time t of the heat-transfer liquid in the hollow plates, in accordance with the value chosen for the difference dT in temperature between these plates.

According to the present invention, this first particular vapour-diffusion distillation method, in which the heat-transfer liquid circulates, preferably by thermosiphon, from the top downwards inside the hot hollow plates and from the bottom upwards inside the cold hollow plates, is moreover characterized in that, according to a first set of arrangements:

a heat exchange for heating is carried out between the flow d of liquid to be distilled entering the installation at temperature T_{L1} and the two flows of distilled and concentrated liquids leaving it, so as to take the temperature of this flow d to a relatively high optimum intermediate value T_{L2};

mixing is carried out between this entering flow d, thus heated to the temperature T_{L2}, and the flow D of heat-transfer liquid exiting from the hot plates at temperature T₃, the ratio d/D being adjusted so that the mixture produced has an optimum temperature T₄ at the inlet to the cold plates.

According to the present invention, this first particular vapour-diffusion distillation method, in which the heat-transfer liquid circulates by thermosiphon, from the bottom upwards inside the hot hollow plates and from the top downwards inside the cold hollow plates, is characterized in that, according to a second set of arrangements, the flow d of liquid to be distilled entering at temperature T_{L1} is added to the flow D of heat-transfer liquid exiting at the temperature T₃ of the hot plates, the ratio d/D being adjusted so that the mixture produced is at an optimum temperature T₄ at the inlet to the cold plates, a flow d of liquid at temperature T₃ or T₄ being poured over the top of the external faces of the hot plates.

Thanks to these last two arrangements according to the invention, a first and a second embodiment of the stills, with vapour diffusion and heat-transfer liquid in counter-current circulation in closed circuit, are possible, the first having however a C_{OP} greater than that of the second, which however remains useful, although the temperatures of the concentrated T₁ and distilled liquids T₂, to be removed are high. This drawback can however be easily corrected if, by appropriate heat exchanges, this thermal energy is recovered in order to reheat the liquid to be distilled to be poured over the top of the hot plates.

According to the invention, a second particular distillation method with vapour diffusion, in particular for producing fresh water, according to the improved general method defined above, in which:

the heat-transfer fluid is said non-condensable gas, saturated with vapour of the liquid to be distilled;

liquid to be distilled is poured over the top of the external faces of the walls of all the distillation-heat-exchange hollow plates, these external faces constituting said hot surfaces S_{c} whilst the internal faces of the walls of these plates constitute said cold surfaces S_{f};

is characterized in that:

the flow of heat-transfer gas at temperature T₁ enters inside all the hollow distillation plates, where it circulates in a first upward or downward direction, whilst some of its vapour condenses on the internal faces of the walls of the plates, flows of heat, resulting from a partial recovery of the latent heat of condensation, pass through the walls of the plates in order to evaporate some of the liquid flowing over the external faces of these walls and, as a result, this flow of gas cools down and finally exits from the hollow plates at temperature T₃;

at the outlet from these plates, this flow of heat-transfer gas at temperature T₃ is cooled down to temperature T₄ and the distilled liquid, condensed on this occasion, is recovered;

then, this flow of heat-transfer gas, at temperature T₄, enters the inter-plate spaces, where it circulates in a second direction, the reverse of the first, carrying away the vapour produced in these spaces and reheating it, and finally it exits from these spaces at temperature T₂;

the distilled liquid, condensed on the internal faces of the walls of the hollow plates, runs down along these internal faces whilst the concentrated liquid runs down along the external faces of these walls;

the optimum temperature T₁ of the flow of saturated heat-transfer gas, at the inlet to the hollow plates, is situated within a range which corresponds to a wide zone around the maximum Intrinsic Efficiency Criterion C_{IE} of the installation;

the optimum temperature T₄ of the flow of heat-transfer gas, which enters the inter-plate spaces, has previously been made as close as possible to the minimum temperature of the available natural cold source present, by cooling down in an appropriate manner the flow of gas at temperature T₃ which exits from the hollow plates;

the difference in temperature (T₁−T₂) is small and the difference (T₃−T₄), considerable.

According to additional characteristics of this improved vapour-diffusion and heat-transfer-gas distillation method,

the correspondence between the optimum range of the temperatures T₁ and the maximum C_{IE} zone is achieved by means of their respective relationships with a composite variable t.dH/V, in which t is the transit time in the plates, dH a more or less constant local difference in enthalpy flows between the internal and external walls of the plates, and V the active volume of the installation;

the useful range of the temperature T1 is approximately comprised between 74 and 91° C.;

the optimum local difference in enthalpy flows dH, between two levels opposite the internal and external walls of the plates, is established by adjustment of the ratio between the heating power and the circulating mass flow of the heat-transfer gas;

the optimum value of dH is relatively high when the cost of the thermal energy easily available at the site of use of the device, is relatively low;

the optimum transit time t of the heat-transfer gas in the heat-exchange plates is established by adjustment of the mass flow D of this gas.

Thanks to these arrangements, the temperature T₄ of the heat-transfer gas, injected at the inlet to the inter-plate spaces, (at the bottom of these spaces in a first case, or at the top in a second) is only slightly higher than the temperature of the liquid to be distilled entering the device (for example 25° C.) and well below the temperature T₃ of this same heat-transfer gas exiting from the hollow plates. Under these conditions, the local difference in enthalpy flows dH, between the flows of heat-transfer gas, with a variable temperature and heat capacity along the whole length of the internal and external faces of the hollow heat-exchange plates, can, over the whole height of these plates, remain more or less constant and equal (except for losses) to that imposed by the appropriate heat source, arranged between the outlet from the inter-plate spaces and the inlet to these same plates. In this regard, it will be noted that the differences in temperature between the flows of heat-transfer gas at the outlet from the hollow plates and at the inlet to the inter-plate spaces, are on the other hand very different. By way of example, there will be a difference (T₁−T₂)=5° C., with T₁=85° C., at one end of the plates and (T₃−T₄)=38° C., with T₃=68° C., at their other end.

According to the invention, this second particular vapour-diffusion and heat-transfer-gas distillation method, is moreover characterized in that, according to a first set of arrangements,

the flow of gas at temperature T₁ is introduced at the top of the hollow distillation plates and it exits at the bottom at temperature T₃;

at the outlet from the hollow distillation plates, this flow of gas at temperature T₃ is subjected to a cooling-down heat exchange, ensured by a cold source at temperature T_{L1}, constituted by the entering flow of liquid to be distilled, in order that, given the respective mass and thermal characteristics of this flow of gas and of this flow of liquid, the temperature T₃ of the flow of gas is reduced to an optimum temperature T₄ and the temperature of the liquid taken to T_{L2};

after this heat exchange, the liquid to be distilled at temperature T_{L2} is reheated by a heat source;

the flow of gas at temperature T₄ is introduced at the bottom of the inter-plate spaces and it exits at the top at temperature T₂;

the flow of gas circulates in closed circuit in the hollow distillation plates and in the inter-plate spaces, under the action of at least one means of propulsion;

at the outlet from the inter-plate spaces, the flow of gas at temperature T₂ is reheated and saturated with vapour, by an appropriate physical contact with the liquid to be distilled reheated by the heat source, so as to take on an optimum or simply effective temperature T₁;

after its physical contact with the flow of gas at temperature T₂, the liquid to be distilled is poured, at a temperature of approximately T₁, over the top of the external faces of the walls of the hollow plates, and it exits at the bottom, at a temperature of approximately T₄;

the distilled liquid, condensed during said cooling-down heat exchange, and that condensed on the internal faces of the hollow plates, are collected, then removed and recovered;

the concentrated liquid is collected at the bottom of the external faces of the walls of these plates, then it is removed and, if appropriate, recovered.

According to the invention, this second particular vapour-diffusion and heat-transfer-gas distillation method is moreover characterized in that, according to a second set of arrangements,

the flow of gas at temperature T₁ is introduced at the bottom of the hollow distillation plates and it exits at the top at temperature T₃;

at the outlet from the hollow distillation plates, this flow of gas is subjected to a cooling-down heat exchange, ensured by a cold source at temperature T_{L1} constituted by the entering flow of liquid to be distilled, so that, given the mass and thermal characteristics of this flow of gas and of this flow of liquid, the temperature T₃ of the flow of gas is reduced to an optimum temperature T₄;

after this heat exchange, liquid to be distilled is poured over the top of the external faces of the walls of the hollow plates, it runs down along these external faces and leaves them at a temperature of approximately T₂;

the flow of gas, at temperature T₄, is introduced at the top of the inter-plate spaces and it exits at the bottom at temperature T₂;

at the outlet from the inter-plate spaces, the flow of gas at temperature T₂ is reheated and saturated with vapour, so as to take on an optimum or simply effective temperature T₁;

the flow of gas at temperature T₁ is introduced at the bottom of the hollow plates and, at least by natural convection, it rises inside these plates, it then passes through a zone where it undergoes said cooling-down heat exchange then, at temperature T₄, it enters and runs down by gravity in the inter-plate spaces;

the distilled liquid, condensed during the cooling-down heat exchange and that condensed along the internal faces of the walls of the hollow plates are collected, then removed and recovered;

exiting from the inter-plate spaces, the liquid to be distilled which has become concentrated is collected with a view to immediate or subsequent removal.

According to a particular characteristic of the method thus defined, the concentrated liquid to be distilled which exits from the inter-plate spaces, is reheated by a heat source and, by an appropriate physical contact with this thus-reheated liquid, the flow of gas at temperature T₂ is reheated and saturated, in order to take on an optimum or simply effective temperature T₁.

According to another particular characteristic of the method thus defined,

the distilled liquid circulates from the bottom upwards in vertical auxiliary hollow plates for heat recovery, separated by narrow inter-plate spaces;

if appropriate, the same applies to the concentrated liquid collected;

these auxiliary hollow plates are both thin, rigid and provided with hydrophilic or wettable external coatings;

liquid to be distilled, preferably at a temperature as low as possible, is poured over the top of these coatings;

some of the flow of gas at temperature T₄ circulates from the top downwards along these thus moistened coatings;

the flow of saturated hot gas leaving these coatings is added to that which exits from the inter-plate spaces of the hollow distillation plates, then the mixture is reheated and saturated in order to take on an optimum or simply effective temperature T₁;

the distilled and concentrated liquids leave at the top of these hollow heat-recovery plates with significantly reduced temperatures, then they are removed and at least one of them is recovered.

By means of these last two chief sets of arrangements, two embodiments of the vapour-diffusion and heat-transfer-gas stills, with counter-current circulation in a closed circuit, in one direction or the other, are possible. In conclusion, commenting on the curves in FIG. 2 above, they have numerous particularly useful advantages, as will be specified in detail hereafter. It will be noted straightaway that the temperatures of the distilled and concentrated liquids which exit from the heat-recovery unit and of the supply of additional vapour to the flow of heat-transfer gas, have relatively small differences compared with the temperature of the entering liquid to be distilled. This has the result of ensuring a high C_{OP} and C_{IE} for the distillation devices concerned.

As regards the boiler, which can be used in the two forms of implementation of each of the two particular improved distillation methods according to the invention, it will be noted that it can take on the most diverse forms, either for heating the liquid to be distilled or for reheating and supersaturating the heat-transfer gas. In principle, if the primary form of heating, which consists of heating by a flame the base of a container in which the liquid to be distilled circulates, is used only as a last resort, it will be advantageously possible, as will be seen below, to use this heating means for reheating and supersaturating the flow of heat-transfer air. The same applies in general to electric heating, for economic reasons. In general, a boiler will be used, the heating chamber of which comprises one or more appropriate heating tubes, for example immersed in or sprinkled by the liquid to be distilled, through which an available heating fluid will pass. Such a heating fluid can be the primary cooling liquid of a heat engine, the exhaust gases of such an engine, the gases produced by a burner of liquid or gaseous fuel, or also a heating oil, heated during the day by a solar boiler with a cylindrical parabolic reflector, and stored at a high temperature (>130° C.), for use day and night, in a heat-insulated reservoir, at atmospheric pressure. An appropriate solar boiler can be used during the day, for reheating and supersaturating the flow of heat-transfer air.

Moreover, if, in stills with vapour diffusion and heat-transfer gas circulating in the hollow plates from the top downwards, it is ensured that the liquid to be distilled, whatever the type of boiler used, is heated to a temperature and a pressure higher than their standard boiling values (102° C. and 60 millibar overpressure, for example, for water), it becomes possible to do away with any mechanical means of propulsion of the heat-transfer gas and replace it with a simple calibrated vapour jet, correctly oriented. This technique produces a result equivalent to that provided by the natural convection which would be obtained with a heat-transfer gas circulating from the bottom upwards in the hollow plates. These techniques both have a considerable benefit for the reliability of stills having to operate outside an industrial environment. The same applies to the vapour-diffusion and heat-transfer-liquid stills, in which this liquid circulates by thermosiphon.

For the implementation of these different particular distillation methods according to the present invention, it is necessary to use several heat-exchange devices, respectively suited to the particular functions which are assigned to them, namely: gas/liquid exchange or liquids/liquid exchange. For simple heat exchanges, without distillation, it is possible to use the heat exchangers available on the market, but their prices appear particularly high, if compared with that of all distillation heat exchangers, in the form of thin and flexible hollow plates, of polymer, described in the PCT Application relating to the prior invention. In the case of a vapour-diffusion still according to the present invention, this renders these exchangers on the market unusable from an economic point of view. As regards the simple heat exchanges provided according to the present invention, the flexible and thin hollow plates described in this PCT Application can ensure these, if they are adapted to their new functions. But, it would be desirable for another type of heat exchanger, better suited to its two types of use, (simple exchange or distillation) to be available under satisfactory technical and economic conditions.

According to another invention of Jean-Paul DOMEN, which is the subject of the international PCT Patent Application entitled “Heat exchanger. Methods and means of producing this exchanger”, filed under No. Fr 03/03692, 12th December 2003, by “TECHNOLOGIES DE L'ECHANGE THERMIQUE”, a compact counter-current heat exchanger, in particular for confined fluids, is described which provides particularly advantageous conditions of implementation for the third embodiment of the present invention. In fact, this new heat exchanger combines on the one hand, four significant technical characteristics, namely: high efficiency, optimum compactness, reduced weight and intrinsic stability and, on the other hand, an essential economic characteristic, which the heat exchangers currently available on the market do not have, namely, a low production cost. Such a heat exchanger is particularly well suited to the standard heat exchange requirement of the four embodiments of the present invention. Moreover, this new type of exchanger makes it possible, by means of an improvement according to the present invention, to design a new architecture for a vapour-diffusion and heat-transfer gas still according to the third embodiment of the invention. This multiplies the benefit and advantageously makes it possible to replace the large, flexible or rigid, rectangular heat-exchange plates described in the PCT Application referred to at the beginning of the present document.

According to the PCT Application concerned, an elementary monobloc heat exchanger with high efficiency, limited space requirement, reduced weight, low production cost and, generally, intrinsic stability,

is constituted by a single active part, in particular made of polymer, formed with neither assembly nor welding, by a stack of pairs of hollow, thin, elongated plates, connecting and globally symmetrical;

the internal faces of the walls of each hollow plate, and similarly the external faces of the walls of two contiguous hollow plates, are at all points separated from each other by narrow, more or less constant spaces;

these pairs of hollow plates constitute the elementary ducts of the active part, which ducts comprise elongated central parts the two ends of which are linked to each other, by two hollow couplings;

each elementary duct of the active part possesses two main feed lines the axes of which are identical with the stacking axes of the end couplings;

one of the ends of each line ends in a connection tube of the active part.

This monobloc element of a heat exchanger can be used either as it is, when it has to be installed in the non-confined flow of a fluid to be reheated or cooled down again, or enclosed in a casing, when the two fluids concerned are confined. In both cases, the most efficient way of using such a heat exchanger is with counter-current operation.

A method for producing such a monobloc heat exchanger comprises the following stages:

producing in a mould, by blow moulding, a blank made from an appropriate material, constituted by a stack of bellows, which are biconvex overall, relatively deep with regard to the transversal dimension of the blank and comparable to those of an accordion, said bellows comprising elongated central parts, provided with end couplings, sides, crests and bases having respectively shapes adapted such that these sides have a much greater rigidity than those of the bases and of the crests, said stack being provided on its side with two connection tubes, centred on the stacking axes of said end couplings;

the elements constituting this blank having appropriate temperatures, flexibilities and elasticities, applying to them an internal vacuum and/or external compression forces, parallel to the stacking axis of the bellows, until the compressed part thus produced becomes a stack of pairs of hollow plates, connected and globally symmetrical, with a more or less constant small internal thickness and spacing;

leaving this part to cool down whilst keeping it in its compressed state;

if necessary after this cooling down, surrounding this part with an element clamping it, in order to keep the gaps between the walls of the pairs of plates at their initial values.

According to the present invention, this new counter-current heat exchanger for confined fluids is provided with an additional function, intended to allow good evaporation of the liquid to be distilled, in a vapour diffusion and heat-transfer gas still. In order to do this, the external wall of the blank of each active heat-exchange element used, is rendered hydrophilic or wettable, either by a hydrophilic coating, if appropriate preformed, in the case of a polymer, or by a chemical polishing treatment, in the case of glass. Such an improved blank can once again be produced by blow-moulding of a pasty sleeve, flattened in shape, produced by an extruder, then introduced into a mould suited to this purpose. In the case of a polymer, the internal walls of the mould will have been previously provided with said hydrophilic coating.

By means of the latter arrangements, the problems of welding, with complex and relatively costly solutions, encountered during the production, installation and use of the large flexible or rigid, rectangular heat-exchange plates, described in the PCT Application concerned, no longer arise. In fact, the only welds to be provided if appropriate for the production of these different compact heat exchangers, used for the implementation of the distillation methods according to the present invention, are those for assembling the constituents of the casing of the active part, said welds being both few in number and relatively easy to produce. The service life of these new heat exchangers depends on that of the material used and, in the case of glass and of a polymer such as polypropylene, it is longer than the service life of the device. One of the additional advantages of this type of monobloc heat exchangers with elongated hollow blades is its extreme compactness. This makes it possible to install, in a given treatment-chamber volume, heat-exchange surfaces, which are in particular more extensive than those obtained with the hollow and flat elements, of large dimensions, described in the PCT Application (i.e. approximately 400 m² per cubic metre, instead of 120). Moreover, as the symmetrical pairs of hollow plates, which make up this compact heat exchanger, can in particular be completely safely brought closer together than large hollow plates (2.5 mm instead of 5 mm), the temperature gradient in the inter-plate spaces of the active element of such an exchanger is multiplied by a factor at least equal to two. Consequently, with compact heat exchangers, making it possible to carry out a distillation, the Intrinsic Efficiency Coefficient C_{IE} of the vapour-diffusion and heat-transfer-gas still which uses them, is multiplied by at least four for each construction. To this, it must be added that, in the case of an active element made of glass, the thermal conductivity of this material is 1.5 W/m.K, i.e. seven times more than that of the polymers. This appreciably increases the total thermal conductance to be taken into account and, in FIG. 2, takes the maximum C_{IE} to a value of 270 instead of 95.

### BRIEF DESCRIPTION OF THE FIGURES

The characteristics and advantages of the present invention will be shown more precisely by the following description of particular embodiments, given as non-limitative examples, with reference to the drawings hereafter in which:

FIGS. 1 and 2 represent the curves commented on in the above preamble;

FIG. 3 represents a diagram of a vapour-diffusion still, using the liquid to be distilled as heat-transfer fluid circulating inside hot hollow plates from the top downwards;

FIG. 4 represents a diagram of a vapour-diffusion still, using the liquid to be distilled as heat-transfer fluid circulating inside hot hollow plates from the bottom upwards;

FIG. 5 represents a diagram of a vapour-diffusion still, using large hollow plates for the distillation heat exchanges and a non-condensable gas, saturated with vapour of the liquid to be distilled, as heat-transfer fluid circulating from the top of these hollow plates downwards;

FIG. 6 represents a diagram of a vapour-diffusion still, using flexible hollow plates for the distillation heat exchanges and a non-condensable gas, saturated with vapour of the liquid to be distilled, as heat-transfer fluid circulating from the bottom of these hollow plates upwards;

FIG. 7 represents the arrangement in perspective of a set of three large thin and flexible, hollow plates, with corrugated walls, which can be used for distillation heat exchanges in a still according to the invention;

FIG. 8 represents the feed device of six even or odd plates of a set of these large flexible hollow heat exchange plates according to the invention;

FIG. 9 represents the means according to the invention for pouring the liquid to be distilled over the coating of the hot hollow plates of a vapour-diffusion and heat-transfer-liquid still;

FIG. 10 represents the profile and top views of a monobloc distillation heat exchanger, with a low production cost, as well as cross-sections of this exchanger and of the blank from which the active element of this exchanger is produced;

FIGS. 11-12 are of the representations in simplified perspective of an overall view and details of a still with vapour-diffusion and heat-transfer-gas still circulating from the top downwards inside rigid hollow plates, forming part of monobloc distillation heat exchangers;

FIG. 13 represents a partial simplified perspective view of a still with vapour-diffusion and heat-transfer-gas still circulating inside flexible, plane, thin, hollow distillation plates from the bottom upwards.

### DETAILED DESCRIPTION OF THE INVENTION

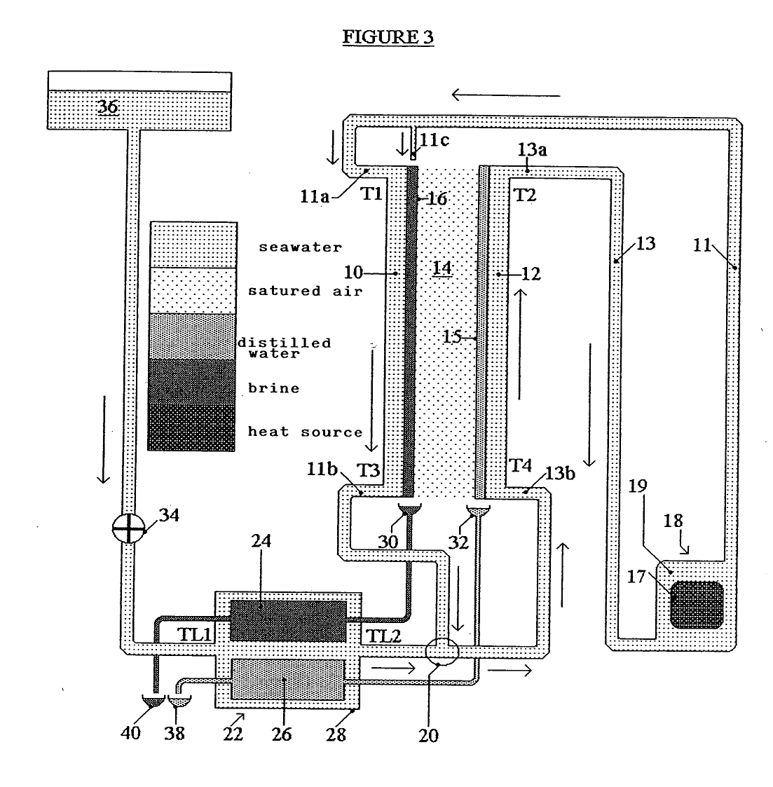

According to the diagram in FIG. 3, which constitutes the first embodiment of a still according to the invention, two plates 10, 12 symbolically represent a vapour-diffusion distillation and heat-transfer-liquid unit, constituted by a set of large rigid cellular plates (50 to 150 dm²), rectangular in shape, installed in the treatment chamber of a vapour-diffusion and heat-transfer-liquid still, according to the present invention. These hollow plates 10, 12 have a small internal thickness (2 to 3 mm for example) and are separated from each other by a narrow free space 14, having a thickness of approximately 5 mm, filled with a non-condensable gas, in particular air at atmospheric pressure. The hollow plate 10 is referred to as hot since it is assigned to the evaporation of the liquid to be distilled and, to this end, it is provided with a hydrophilic or wettable coating 16. The hollow plate 12 is referred to as cold since it is assigned to the condensation of the vapour diffused in the non-condensable gas. It comprises, preferably, an identical coating 15. A boiler 18, provided with a heat source 17 and a heating chamber 19, situated a good distance below the top of the plates 10, 12, is arranged between the high ends of these plates and connected to these ends by pipes 11 and 13 and coupling devices 11a and 13a. This boiler 18 causes a heat-transfer liquid constituted by the liquid to be distilled to circulate in these hollow plates 10, 12, in closed circuit and by thermosiphon. This boiler 18 is of any available type, in particular with a solar collector or burner. The circulation of the heat-transfer liquid takes place in the hot evaporation plate evaporation 10 from the top downwards and in the cold condensation plate 12 from the bottom upwards. The temperature of the liquid entering the plate 10 is T₁ and that of this same liquid, poured over the top of the coating 16, by means of an appropriate device 11c, quickly becomes slightly lower than T₁, because of its rapid evaporation. During its passage through the hollow hot plate 10, the heat-transfer liquid is cooled down whilst the liquid poured over the coating 16 evaporates 16 and its vapour diffuses in the non-condensable gas. The temperature of the heat-transfer liquid at the outlet from this plate 10 is T₃. The liquid which exits from the hot plate 10, through a coupling device 11b identical to 11a, enters a mixer 20 which receives by gravity seawater to be distilled, originating from a counter-current heat exchanger 22. This exchanger 22 is of the compact, low-cost type, which is described in detail hereafter. This exchanger 22 comprises two active exchange elements 24, 26 and a casing 28 enclosing them. These active elements are connected to the two collecting troughs 30, 32 of the salt water and of the distilled water which flows off the coating 16 of the evaporation plate 10 and the coating 15 of the condensation plate 12. In the casing 28, cold seawater circulates originating, through a flow control valve 34, from a reservoir 36 arranged above the plates 10, 12. At the outlet from the exchanger 22, the fresh water and the salt water are discharged into drainage troughs 38, 40. The temperature of the seawater in the reservoir is T_{L1} and that of the reheated liquid exiting from the exchanger 22, to enter into the mixer 20, is T_{L2}. At the outlet from the mixer 20, the temperature of the seawater to be distilled is T₄. In the still, the ratio D/d of the flow rates of the circulating D and entering liquids d is comprised between 8 and 12, as a function of the efficiency of the exchanger 22 and of the usual temperature of the flow entering. The seawater exiting from the mixer 20 enters the cold plates 12 through a coupling device 13b, identical with to the device 13a. The condensation of vapour on the external face of the plate 12 causes a progressive increase in the temperature of the circulating liquid, so that, at the outlet from the plate 12, this liquid is at a temperature T₂. The fresh water, condensed on the external face of the plate 12, flows off at a temperature of approximately T₄, and the salt water, at the bottom of the coating 16, at a temperature of approximately T₃.

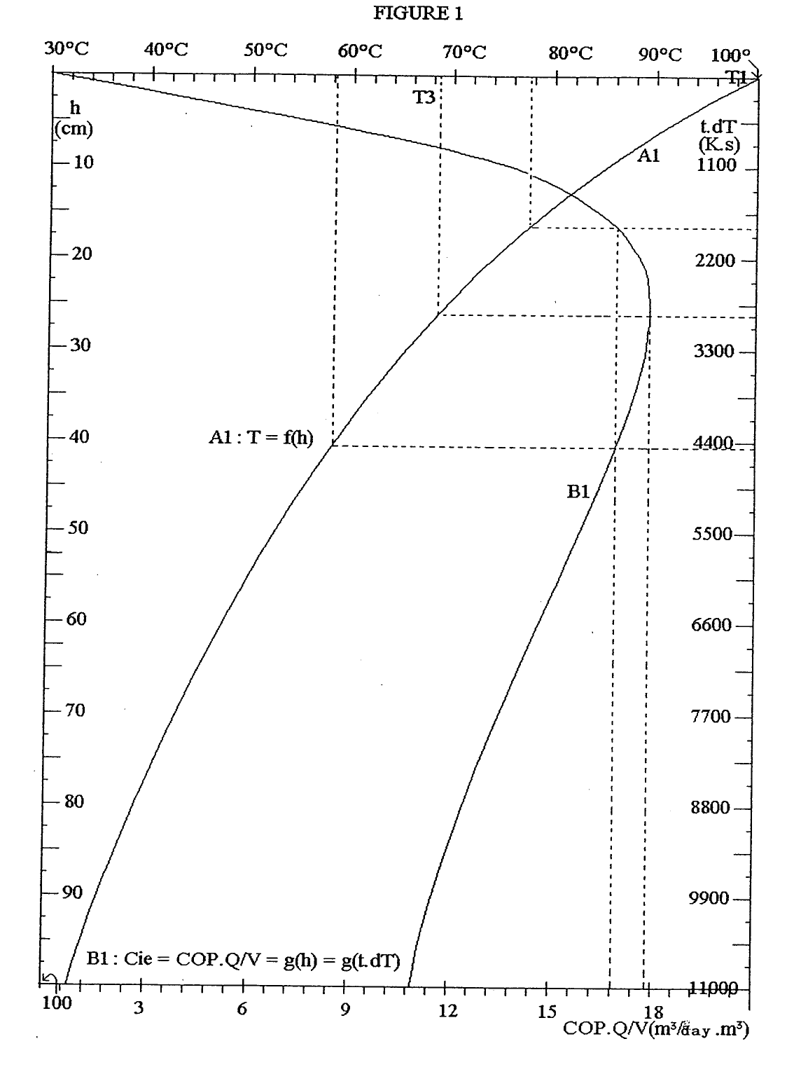

In order to assess the efficiency of such a vapour-diffusion still, implementing heat exchanges with a counter-current of water, two numerical examples will be carried out. By way of example, the compact heat exchanger 22 being outside the circuit, the cold seawater at 25° C. is directly mixed with the heat-transfer liquid exiting from the hot plates 10 at T₃. Given the ratio, generally comprised between eight and ten, existing between the two flow rates D and d, the temperatures at the ends of the plates are, for example, the following: T₁=99° C., T₂=95° C. T₃=68° C. and T₄=64° C., with dT=4° C. and C_{OP}=(T₁−T₃)/dT=8. But if the price of the energy at the site is high, it is necessary to increase the value of C_{OP} as well as possible, by reducing the value of dT. By way of example, if a gross C_{OP} of approximately 16 is desired, the value of dT=(T₁−T₃)/16. This result can be obtained without heat exchanger 22, as in the preceding case, for a value T₃=54° C. and dT=2.8° C., by adjusting the thermal power P of the boiler and the flow of the circulating liquid D. This new value of T₃ is outside the optimum range of the outlet temperatures of the hot plates. According to the curve B in FIG. 1, for a temperature T₃=54° C., we have a C_{IE} value of 15.6 instead of 17.8 in the middle of the optimum range of T₃, i.e. 12% less and therefore a daily production of 12% lower, for an unchanged C_{OP} and active volume of still. On the other hand, if the compact, low-cost heat exchanger 22 is utilized, in order to take the seawater to be distilled to a temperature of 45° C. and therefore the difference dT to 2° C. and T₃ maintained at 68° C., the value of C_{IE} remains 17.8. This improvement results in an increase in the price of the still equal to the price of the exchanger 22. With a compact, low-cost heat exchanger, of the type described hereafter, this price is low, in contrast to the high price of the other useable heat exchangers available on the market, and the increases in the distillation C_{OP} and C_{IE} which result, for a still thus equipped, are perfectly justified from the economic point of view. It will be noted that the calculation demonstrates that any increase relative to the C_{IE} of distillation of a vapour-diffusion still allows a symmetrical relative reduction in the total heat-exchange surface utilized, without however modifying the distilled flow rate and the energy consumed. The economic consequence of such a reduction is the difference between the relatively high acquisition and amortization costs of the hollow heat-exchange plates saved, with a relatively short service life (less than five years), and the relatively low, similar costs of the compact heat exchanger used, which both benefit from a low construction cost and particularly long service life.

Consequently, with a vapour-diffusion still with counter-current of water, according to said first embodiment, which uses large heat-exchange plates, of the type described in said prior invention, and which operates at optimum temperatures T₁ and T₃, in accordance with the present invention, the use of a compact, low-cost heat exchanger is particularly advantageous. In fact, this type of exchanger makes it possible, for a reduced cost, to bring the cold seawater entering the still to a relatively high temperature which, after mixing, brings the seawater entering the cold plates to a higher optimum temperature. This optimum temperature is obtained by giving an appropriate C_{OP}, by construction, to the exchanger used. This intermediate result for a still with a given active volume V, leads to an improved distillation efficiency, obtained under advantageous economic conditions as regards the daily volume of production of fresh water.

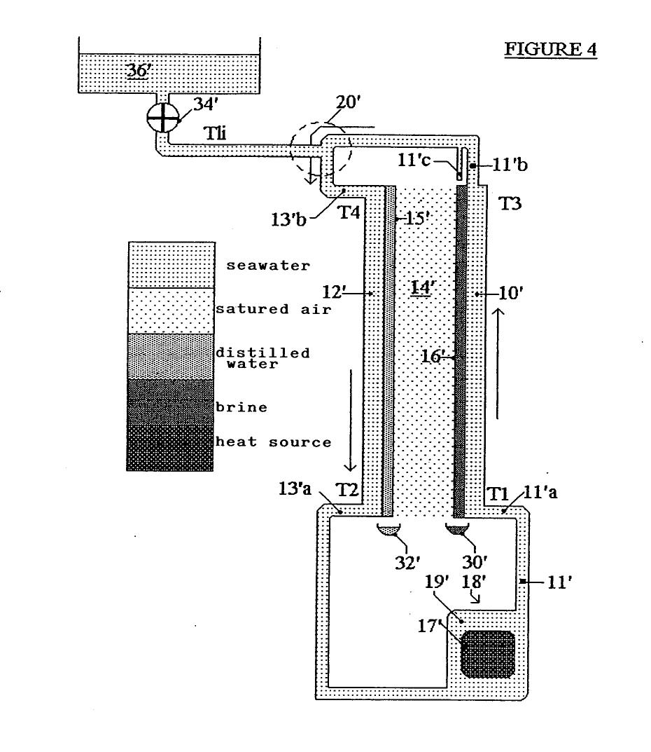

FIG. 4 represents a diagram of a vapour-diffusion still, according to the second embodiment of the invention, in which the direction of circulation of the heat-transfer liquid in the hot plates is from the bottom upwards, the reverse of that in FIG. 3. Consequently, the components of the two distillation units in FIGS. 3 and 4 are identical, and the diagram is more or less symmetrical to that in FIG. 3, their other components being identical or equivalent. They have been given all the same numerical references, with however an additional sign (′) for those in FIG. 4. This is in order to differentiate them from each other, the ways in which they are connected together being different. The inlet to the hot hollow plate 10′ is connected, by its bottom coupling 11′a and a duct 11′, to the outlet from the heating chamber 19′ of a boiler 18′ equipped with a heating tube 17′. The outlet from the hot plate 10′ is connected, by its top coupling 11′ b, to one of the inlets to a mixer 20′, the other inlet to which is connected to a reservoir 36′ containing the seawater to be distilled. The outlet from this mixer 20′ is connected to the inlet to the cold hollow plate 12′, by a duct 13′b. The outlet from this plate 12′ is connected, by its bottom coupling 13′a, to the inlet to the heating chamber 19′ of the boiler 18′. The salt water and the fresh water produced are removed by troughs 30′ and 32′.

By means of these arrangements, the temperatures at the inlets and at the outlets of the hot 10′ (T₁, T₃) and cold 12′ (T₄,T₂) plates are more or less identical to those which it is possible to have with the still according to FIG. 3.

The same applies with regard to the operation of the distillation carried out. As regards the overall efficiency of this still according to FIG. 4, it is very clearly below that of the still according to FIG. 3, since the temperatures of the fresh water and of the salt water removed (approximately T_{1 and T}₂) are much higher than those (approximately T₃ and T₄) obtained in the case in FIG. 3. This type of still however remains a second advantageous possibility for implementation of one of the heat-transfer-liquid distillation methods according to the invention, since this drawback can be easily corrected. In fact, it is simple to considerably reduce the temperature of the distilled and condensed liquids to be removed, by means of a double heat exchanger (identical to that referenced 22 in FIG. 3), circulation takes place in the reverse direction in which, in order to better reheat the liquid to be distilled to be poured over the hydrophilic coatings of the hollow plates, it is circulated in the reverse direction.

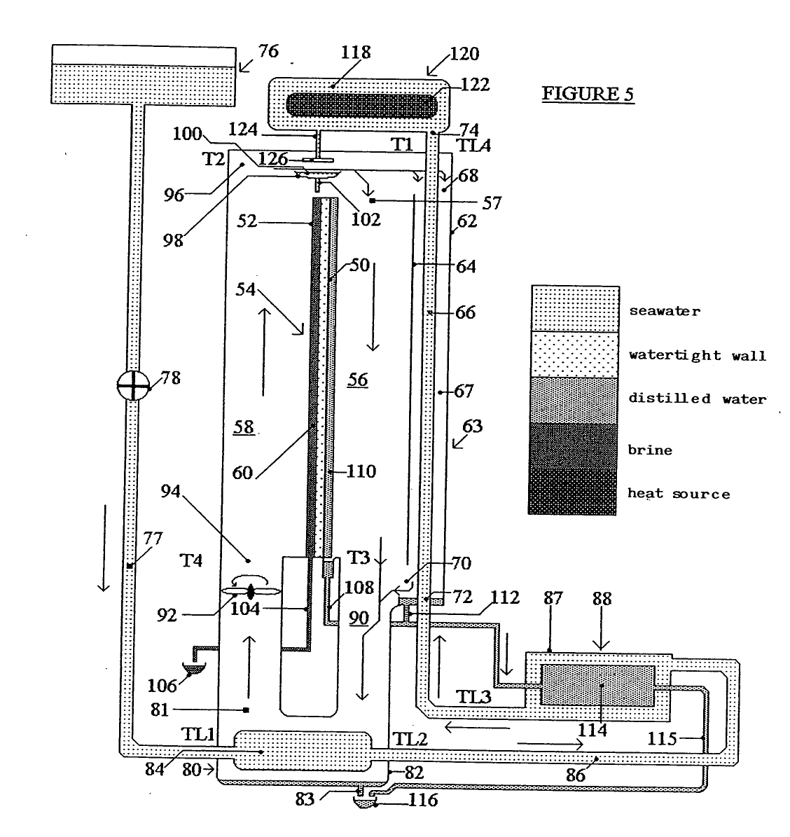

FIG. 5 is a flow diagram of a first vapour-diffusion still using air, saturated with vapour of the liquid to be distilled, as heat-transfer fluid. It has the characteristic of causing the air to circulate inside hollow distillation plates from the top downwards. This device constitutes the third embodiment of a still according to the invention.

According to this FIG. 5, the internal 50 and external faces 52 of one of the two walls of a large rectangular hollow distillation plate 54 respectively border its internal volume 56 and the free space 58 which separates two adjacent plates. This plate 54 symbolically represents a vapour-diffusion and heat-transfer-gas distillation unit, constituted by a large number N of flexible or rigid hollow distillation plates, separated by narrow inter-plate spaces. The external face 52 of the wall of the plate 54 comprises a hydrophilic coating 60. In the vicinity of these first N hollow plates, a reduced number n of auxiliary hollow plates for preheating the liquid to be distilled are arranged. They are similar to the preceding (N) plates but without coating. These n auxiliary hollow plates are symbolically represented by a tube 66, passed through by the liquid to be distilled, which occupies a space 67, delimited by the internal faces of the walls 62, 64 of a casing 63. The major part of the flow of hot heat-transfer air enters the top end 57 of the hollow plate 54 and a small part enters that 68 of the space 67. By a passage 70, the bottom of the space 67 is connected directly to the outlet from the inside 56 of the hollow plate 54. The tube 66 is provided at the bottom with an inlet 72, and at the top with an outlet 74. A reservoir 76, containing the liquid to be distilled (brackish water, for example), at temperature T_{L1}, is installed above the still and, by gravity, it feeds this still through a flow control valve 78 and a tube 77. The liquid to be distilled is firstly introduced into an appropriate heat exchanger 80, with counter-current operation. This exchanger 80 comprises, in a casing 82, a monobloc active element 84. The inlet to the active element 84 is connected to the tube 77 taking the non-potable water to be distilled and its outlet is connected, by another tube 86, to the inlet to the casing 87 of a compact heat exchanger 88, with counter-current operation. The inlet to the casing 82 of the heat exchanger 80 is passed through by the flows of air exiting from the N hollow distillation plates 54 and from the n auxiliary preheating hollow plates 66 and, to this end, this inlet is connected to their common outlet 90. The outlet 81 from the casing 82 is connected upstream of the helix of a ventilator 92, installed in the bottom part 94 of the inter-plate space 58. The distilled water, condensed on the walls of the active element 84 of the heat exchanger 80, accumulates at the bottom of its casing 82 and is removed by a duct 83.

Above the N hollow plates 54, in 96 a long tray 98 is arranged, covered with a spongy mat 100, (a thick layer of fabric, for example), provided with a base perforated by numerous holes connected to distribution ducts 102, installed just above the coatings 60 of these N plates 54. The duct 104 collecting the salt water, which flows off at the bottom of the coatings 60, opens into a drainage trough 106. The duct 108 collecting the thin film 110 of distilled water, which trickles down over the internal faces 50 of the walls of the N hollow plates 54, is joined by the duct 112 collecting the distilled water, condensed on the external walls of the tube 66 symbolizing the n auxiliary preheating hollow plates, before being connected to the inlet to the monobloc active element 114 of the heat exchanger 88. The outlet 115 from this element 114 as well as the outlet 83 of the casing 82 opens into a drainage trough 116 for distilled water. The casing 87 of the heat exchanger 88 is passed through by the liquid to be distilled, its outlet being connected to the inlet 72 of the tube 66, representing the n plates for preheating this liquid. The outlet 74 from the tube 66 is connected to the inlet to the heating chamber 118 of a boiler 120, provided with a heat source 122. The heating chamber 118 possesses an outlet duct 124 which feeds a sprinkler 126, installed lengthwise just above the spongy mat 100 covering the tray 98. The maximum temperature of the brackish water to be distilled contained in the heating chamber 118 is below its boiling temperature.

By means of these arrangements, the heat source 122, for example adapted to supply brackish water with a maximum value of 95° C., for a given entering flow of this water, fixed once for all by an appropriate adjustment of the valve 78, governs the whole operation of a vapour-diffusion and heat-transfer-gas still, in accordance with the new characteristics of the methods according to the present invention. The hot water, provided by the heating chamber 118 at a temperature of 95° C., falls as rain on the spongy mat 100. Placed in the flow of heat-transfer air exiting at the top 96 of the inter-plate space 58, at a temperature T₂ (80° C., for example), appreciably below that of this rain and of the water impregnating the fabric 100, this water evaporates in part and cools down appreciably, to 87° C., for example. Through the outlet ducts 102, this water is poured over the top of the hydrophilic coatings 60 of the N hollow distillation plates 54. The flow of heat-transfer air, which has circulated through said rain and along the tray 98 and its spongy fabric 100 soaked with hot water, is reheated to T₁=86° C. and, saturated with vapour, introduced inside the N hollow plates 54 and around the tube 66. During its descent in these plates, the vapour carried along by this flow of air condenses on their internal faces, whilst this flow of air cools down, the brackish water which flows along the coating 60 evaporates in part and that which rises in the tube 66 heats up again. At the bottom of the N hollow distillation plates 54, the temperature T₃ of the heat-transfer air is 68° C. and, at the bottom of the n auxiliary hollow plates for preheating the liquid to be distilled represented by the tube 66, the temperature of this air is approximately 42° C. At the inlet to the casing 82 of the heat exchanger 80, the temperature of the mixture is approximately 62° C.

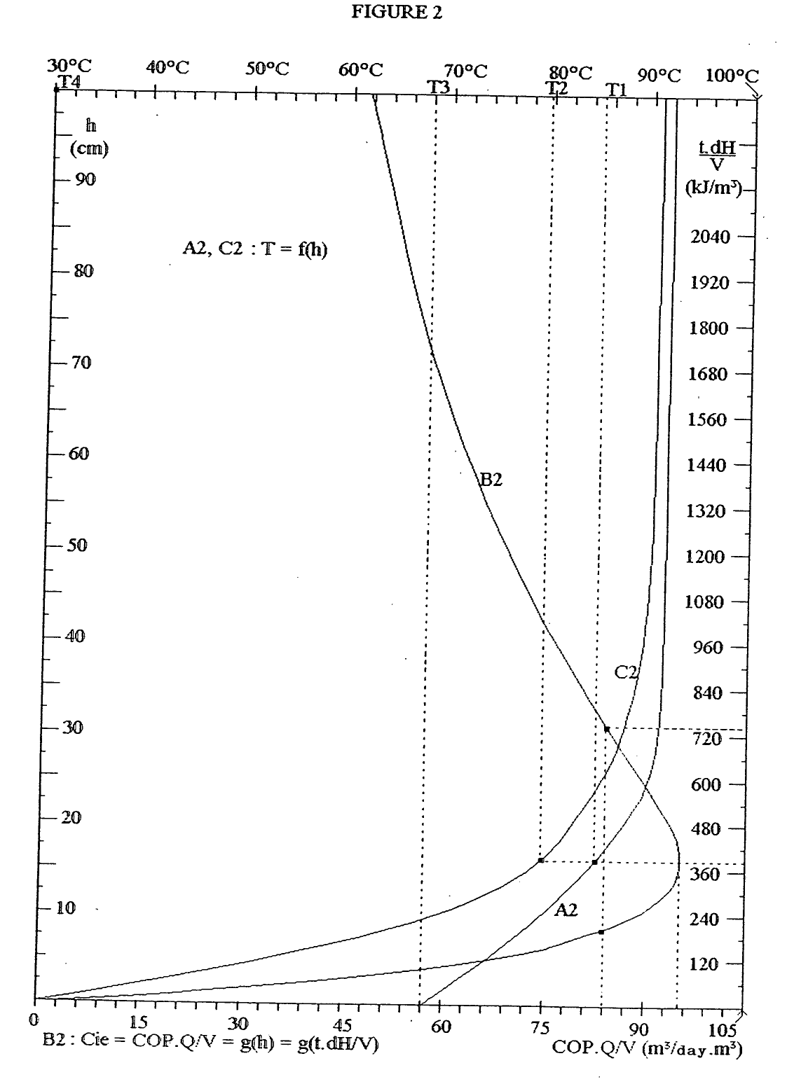

The liquid to be distilled enters the active element 84 of the heat exchanger 80, at a temperature T_{L1} of 25° C. for example. There it circulates in counter-current with the heat-transfer air. With an exchanger 80, with a high efficiency coefficient, during its passage through the element 84, the liquid gains 5° C. whilst the flow of heat-transfer air, which has passed through the casing 82 loses 32° C. to return to a temperature T₄ of 30° C., upstream of the helix of the ventilator 92, installed at the bottom of the inter-plate space 58. In order to prevent the electric motor of the ventilator 92 from being damaged under the action of the saturated hot air, this motor is arranged outside. When it is rising in the inter-plate space 58, the flow of heat-transfer air heats up again and arrives at the top 96 of this space at a temperature T₂ of 80° C. On exiting from the active element 84, the brackish water is at a temperature T_{L2} of only 30° C., because of the very different respective calorific capacities and of the respective mass flow rates of the two fluids concerned. As regards the temperature T_{L3} of the brackish water exiting from the casing 87, its value is approximately 50° C. The four temperatures T₁ to T₄ appear in FIG. 2: T₁=86° C., T₂=80° C., T₃ 68° C. and T₄=30° C. If the exchanger 80 had had a lower efficiency coefficient and/or if the temperature T_{L1} had been higher, the temperature T₄ could have been 40° C. instead of 30° C. and, in this case, the temperature T₃ which would have resulted would have been 72° C. instead of 68° C. The efficiency of the distillation then carried out would then have been reduced since the third expression of C_{IE} is k.(T₁−T₃).

The brackish water which flows off the coating 60 of the N hollow distillation plates 54 is at a temperature of approximately T₄ (30° C.), i.e. at a temperature close to that (25° C.) of the brackish water to be distilled. Consequently, it is removed directly by the duct 104 and the trough 106. On the other hand, the distilled water at the inlet to the active element 114 of the counter-current heat exchanger 88 is at a temperature of approximately 62° C., the same as that of the heat-transfer air at the inlet to the casing 82 of the heat exchanger 80. It is therefore completely justified to recover the thermal energy from this distilled water and ignore that carried away by the salt water. As the flow of distilled water at 62° C. circulating in the active element 114 of the heat exchanger 88 is weaker than that of the brackish water at T_{L2}=30° C. which passes through its casing 87, the temperature T_{L3} of the brackish water which exits from it is only approximately 52° C. For its part, the brackish water which exits from the n auxiliary hollow plates (tube 66) is T_{L4}=75° C., i.e. 11° C. less than the temperature T₁ of saturated hot air at the inlet to the space 67. The brackish water at 75° C. which enters the heating chamber 118 of the boiler 120 gains 20° C. there.

The ratio between the total surface area of the N distillation plates 54 and that of the n auxiliary plates symbolized by the tube 66 is approximately six to ten and the heat exchangers 80 and 88 are, by construction, suited to the results sought. As has been indicated above, the optimum value of the composite variable t.dH/V is relatively high, when the boiler 120 is fed by free thermal energy (solar boiler or cooling water of a heat engine, for example).

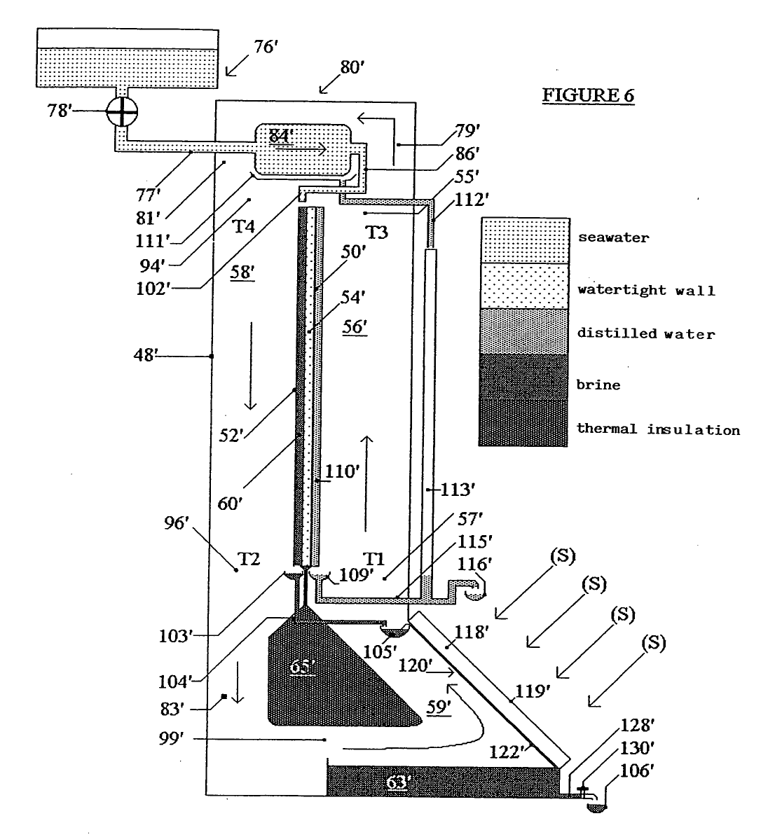

FIG. 6 is a flow diagram of a second vapour-diffusion still using air, saturated with vapour of the liquid to be distilled as heat-transfer fluid. This device has the characteristic of causing the flow of heat-transfer air to circulate inside the hollow plates from the bottom upwards, which is the reverse of that in FIG. 5.

Consequently, the components of the two distillation units are identical and this diagram is more or less symmetrical to that in FIG. 5, several of their other components being identical or equivalent.

All have been given the same numerical references, but with an additional sign (′) for those in FIG. 6. This is in order to differentiate them from each other, the ways in which they are connected together being different. This device constitutes the fourth embodiment of a still according to the invention.

According to FIG. 6, in a heat-insulated treatment chamber 48′, represented by a frame of unbroken lines, a wall 54′ of a thin and flexible hollow plate, possessing an internal space 56′ and an inter-plate space 58′ between two contiguous two plates, is drawn. In order to simplify the drawing, these two spaces 56′ and 58′ are limited by the lines defining the chamber 48′. The mixture assembly symbolically represents a distillation unit with vapour-diffusion and heat-transfer-gas distillation unit circulating by natural convection. Each hollow plate comprises two walls 54′, two bare internal faces 50′ and two external faces 52′ provided with a hydrophilic coating 60′, as well as an inlet 57′, situated in its bottom part, and an outlet 55′, situated in its top part. The inlets 57′ of the hollow plates of said assembly are connected by a bottom vent 59′, of appropriate height, to a saturated hot air generator, described hereafter. The outlets 55′ of the hollow plates open into a large space 79′, of appropriate height, occupied by a monobloc active heat exchange element 84′f. This space 79′ constitutes the top vent of the treatment chamber 48′ of the still. It extends beyond the active element 84′ through another wide space 81′ which ends above the inlets 94′ of the inter-plate spaces 58′ of said assembly. The outlet 96′ of the inter-plate space 58′ opens into a wide collecting space 83′.

A reservoir 76′, containing for example seawater to be distilled, is installed at an appropriate distance above the treatment chamber 48′ to feed the monobloc active heat exchange element 84′ by gravity, through a tube 77′ and a valve 78′. The outlet from this element 84′ is connected by a tube 86′ to spouts 102′, arranged just above the top edges of the walls of the hollow plates 54′ of said assembly and of their hydrophilic coatings 60′. The salt water which runs down along the coatings 60′ ends in a single collecting trough 103′, connected by a tube 104′ to another trough 105′, intended to feed a particular solar boiler 120′ with salt water. This solar boiler 120′ is adapted to evaporate some of this salt water and to diffuse its vapour in a flow of air, in order to constitute said saturated hot air generator. To this end, the base of the heating chamber 118′ of this boiler 120′ is constituted by a black fleece 122′ made of composite material (for example, film made of polymer or oxidized metal foil with an isolated backing on the one hand, and cellulose or polymer non-woven, on the other), impermeable and unalterable on the black side and more or less hydrophilic on the other. This fleece 122′ is installed on a rigid grid and its black face, obliquely exposed to solar radiation (S) in accordance with the latitude of the site, is protected from the ambient air by a transparent wall 119′. This transforms this heating chamber 118′ into a solar collection unit. The upper edge of the fleece 122′, with hydrophilic coating, forms a free roof slope which dips into the feed trough 105′. The inlets 57′ of the hollow plates are arranged just above the tube 104′ and the upper edge of the heating fleece 122′ and its thin hydrophilic mat, constantly moistened by capillarity and gravity. A reservoir 63′, arranged under the heating fleece 122′, occupies a large part of the base of the treatment chamber 48′. Above the part upstream of this reservoir 63′ is installed an isolating block 65′ which, on the one hand, separates the outlets 96′ of the inter-plate spaces 58′ from the inlets 57′ to the insides 56′ of the hollow plates and, on the other hand, delimits a passage 99′ constituting the inlet to the bottom vent 59′ of the treatment chamber 48′ of the still. This reservoir 63′ is intended to collect the salt water which flows down from the hydrophilic coating of the fleece 122′. The reservoir 63′ comprises a drain tube 128′, provided with a valve 130′ arranged upstream of a salt water drainage trough 106′, both installed outside chamber 48′. The distilled water, which condenses into a film 110′ on the internal faces 50′ of the walls 54′ of the different hollow plates, is collected in a single trough 109′, itself connected by a tube 115′ to a drainage trough 116′, installed outside of the chamber 48′. As regards the distilled water, condensed on the external faces of the active heat exchange element 84′, it is collected in a trough 111′ connected by a duct 112′ which opens at the top of a vertical tube 113′, open to the outside air, ending in the drainage trough 116′.

By means of these arrangements, in the circuit in closed loop thus formed, the black face of the fleece 122′, installed on the base of the solar collection unit 118′, absorbs the solar radiation (S), heats the salt water which impregnates the thin hydrophilic mat on its other face, evaporates some of its water and diffuses the vapour produced in the air which surrounds it. In this way, this air is thus progressively reheated and kept saturated and it becomes, by natural convection, a flow of saturated hot air which passes through the bottom vent 59′ then penetrates to the insides 56′ of the hollow plates, by their inlets 57′, and then it circulates from the bottom upwards in these vertical hollow plates then in the top vent 79′ and along the external faces of the monobloc active heat exchange element 84′. This heat exchange element 84′ is passed through by the flow of seawater to be distilled entering the still. Passing along the walls of this element 84′, the flow of air cools down, then it runs down by gravity in the space 81′, the inter-plate spaces 58′ and the passage 99′ then, subjected to the draught engendered by the heating fleece 122′, it sweeps the surface of the hot salt water contained in the reservoir 63′ and that of the constantly moistened hydrophilic face of the fleece 122′, which soaks in the feed trough 105′, thus looping the passage taken in closed circuit. The height which separates the lower edge of the heating fleece 122′ from the edge upstream of the heat exchange element 84′, must be relatively great. It is adjusted once for all by setting of the heights of the bottom and top vents 59′ and 79′. This is done in order that the speed v of rising circulation of the flow of heat-transfer air, to the inside 56′ of each hollow plate is sufficiently great (20 to 50 cm/s). Under these conditions, given the local difference in enthalpy flows per unit of active volume dH/V of the hollow plates, engendered by the boiler 120′ between the inlet 57′ of the insides 56′ of the hollow plates and the outlet 96′ of the inter-plate spaces 58′, a possible optimum value at of the transit time t of this flow in the hollow plates can be determined. This is done on the basis of the optimum range of the values of the composite variable t.dH/V arbitrarily delimited by the values of C_{IE} greater than 84 m₃/day.m₃. namely 200 to 740 kilojoules per cubic metre (see curve B2 in FIG. 2). The height of the distillation plates and those of the bottom and top vents are chosen at the same time, given the maximum value of the temperature T₁ (which must remain comprised within the range concerned of its optimum or simply effective values) of the flow of air circulating by natural convection, that the solar boiler 120′ can produce.

At the level of the inlets 57′ of the hollow plates, the temperature T₁ of the flow of air is limited because of the solar boiler without reflector used, but this temperature remains in its optimum range, i.e. approximately between 70 and 80° C., at least when the sun is at its highest point. Passing through the space occupied by the active heat exchange element 84′ of, passed through by the seawater entering at a temperature of 25° C., the flow of air which exits from the hollow plates at a temperature T₃ of approximately 68° C. is cooled down and its temperature falls to an optimum value T₄ which is very low, namely approximately 30° C., when the efficiency of the monobloc active element 84′ is appropriate.

The outlet tube 86′ of the active element 84′ of the heat exchanger 80′ feeds the spouts 102′ with seawater at a temperature of approximately 50° C. This tepid seawater thus poured over the coatings 60′ runs down slowly along the external faces 52′ of the walls 54′ of the hollow plates. Consequently, the water vapour carried along by the flow of saturated hot air, which rises inside 56′ the hollow plates, condenses on the internal faces 50′ of the walls of these plates and forms a thin film of distilled water 110′. While the seawater runs down in the coatings 60′, this seawater heats up again, under the action of the latent heat of condensation recovered through the walls 54′ of the hollow plates. Therefore, this water evaporates in part and the vapour produced diffuses in the flow of air cooled down, which runs down in the inter-plate spaces 58′, and thus progressively reheats this flow. At the outlet from these inter-plate spaces, the temperature of this flow of air reaches a value T₂ of approximately 78° C. As regards the salt water, collected at the bottom of the hydrophilic coatings 60′ of the walls 54′ of the hollow plates, its temperature is also approximately 78° C. This salt water collected by the trough 103′ is taken by the duct 104′, into the feed trough 105′, by capillarity and gravity, from the rear hydrophilic coating of the fleece 122′ to the front black face, installed at the base of the heating chamber 118′ of the particular solar boiler 120′. The maximum temperature of this heating fleece 122′ and of the salt water that its coating contains is with at the most 85° C. (such a solar boiler without reflector scarcely makes it possible to reach a higher temperature). A small part of the water of this salt water evaporates and the remainder flows slowly into the reservoir 63′, which thus gradually fills with slightly more concentrated salt water, the temperature of which is approximately 82° C., intended to be removed. The vapour thus produced at the surface of the hydrophilic coating of the heating fleece 122′ is carried along by the flow of air which has discharged from the inter-plate spaces 58′ then swept the surface of the hot salt water contained in the reservoir 63′ and, with approximately one degree thus gained, penetrates with a temperature of slightly more than 78° C., at the foot of the hot constantly moistened coating of the fleece 122′, along which it heats up again and is saturated once again.

It will be noted that is possible to pour the seawater from the reservoir directly over the coating 60′ in place of the tepid seawater exiting from the heat exchanger 84′. In this case, this tepid water is directly removed. The temperatures T₄ and T₂ are slightly affected by this but the general operation and performances of the assembly are scarcely modified.

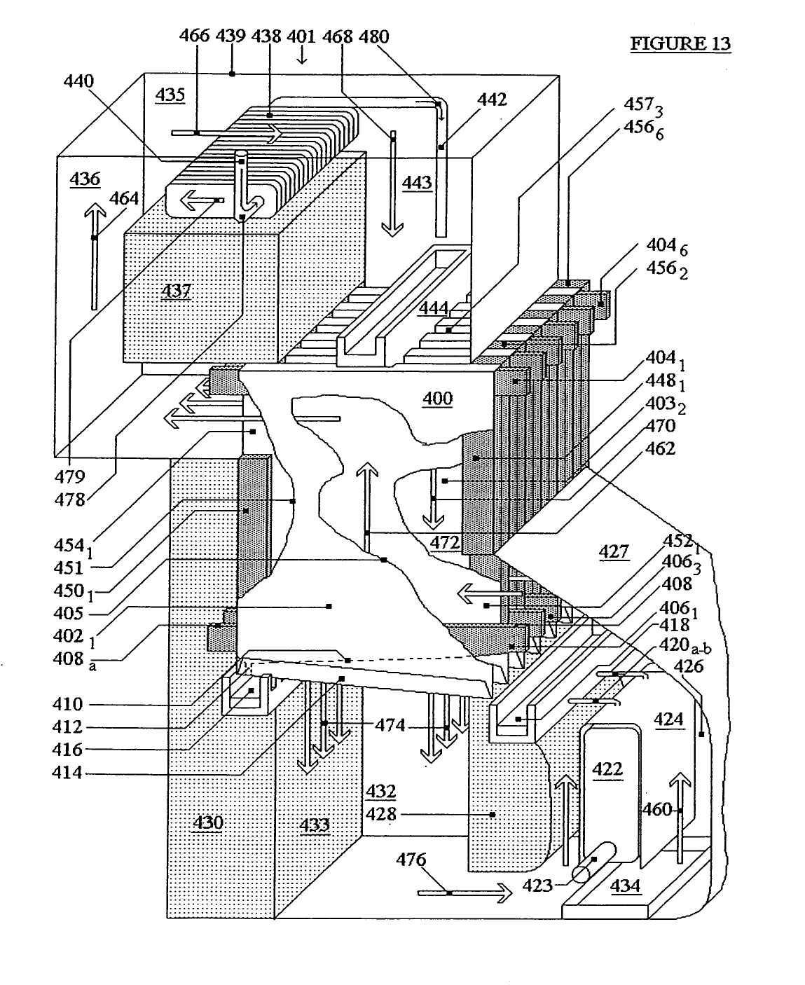

The advantage of this vapour-diffusion still with a flow of heat-transfer air circulating in the hollow plates from the bottom upwards, is multiplied if compared to the still in FIG. 5, in which the flow of heat-transfer air circulates inside these plates from the top downwards. The first advantage resides in the fact that no means of propulsion (ventilator or vapour jet) is necessary to ensure the circulation of this flow of air, since this circulation is here engendered by natural convection. The second advantage results from the fact that the temperature of the heat source can be comprised between approximately 75° and 885° C. and however remain effective since capable of ensuring, at the inlet to the hollow plates, a temperature T₁ which is also optimum or simply effective. This has the direct consequence of adding a third advantage, namely to render a solar boiler without a reflector perfectly suitable for such a still. A fourth advantage resides in the total absence of moving parts operating permanently. This constitutes a particularly useful advantage (no need for any of the maintenance generally required by such parts) in all cases where this type of still is used in a non-industrial environment. A fifth advantage appears in the fact that a very considerable performance coefficient C_{OP} of the still can in principle be obtained, since the increase in the temperature of the salt water, supplied by the boiler, can be very small (<2° C.). In the still according to this FIG. 6, the temperatures of the salt water and of the distilled water to be removed are high (approximately 82° C.), but it will be described hereafter, in comments on FIG. 13, how it is possible to recover this thermal energy in order to diffuse additional vapour into the flow of heat-transfer air and thus considerably increase the C_{OP} of the device. A sixth advantage originates from the considerable increase in the C_{IE}, referred to above, which results from the very small wall and hydrophilic coating thickness of the new type of thin hollow plate, with very fine, flexible, plane walls, described hereafter in FIG. 13. The comments, which accompany this FIG. 13, relate to an actual embodiment of a vapour-diffusion still with heat-transfer gas, circulating in closed circuit by natural convection. They will confirm, by the low production cost of this new hollow distillation plate, the particularly great advantage of this last embodiment of the invention.

It will be noted that with such a solar-boiler still, it is possible to produce fresh water after the end of the effective insolation of the installation site. This firstly requires a well heat-insulated reservoir 63′ which is moreover, deep enough to be able to contain at least all the salt water produced during one day's insolation. By keeping the drain valve 130′ closed after sunset and reducing (for example by half) the flow of seawater entering, by action on the valve 78′, the production of fresh water by this solar still on can be extended late into the night and thus increase the day's production by approximately 20%. This result is obtained by means of the additional reheating and saturation provided for the flow of air which sweeps the surface of the large mass of hot salt water contained in the reservoir at the end of the day and constantly re-fed with a salt water the temperature of which is slightly below its own. As the temperature of this salt water drops, the flow rate of distilled water will do the same until it ends up just dripping. The normal operation of the still will be resumed in the morning and will simply comprise emptying the reservoir by opening the valve 130′ provided for this purpose for a moment, and giving the flow of seawater entering its day-time value (which will in general depend on the maximum intensity of the solar radiation to be provided for the day). Under these conditions, the temperature of the salt water removed in the morning is relatively low and the overall C_{OP} as well as the overall C_{IE} of such a solar still are appreciably improved.

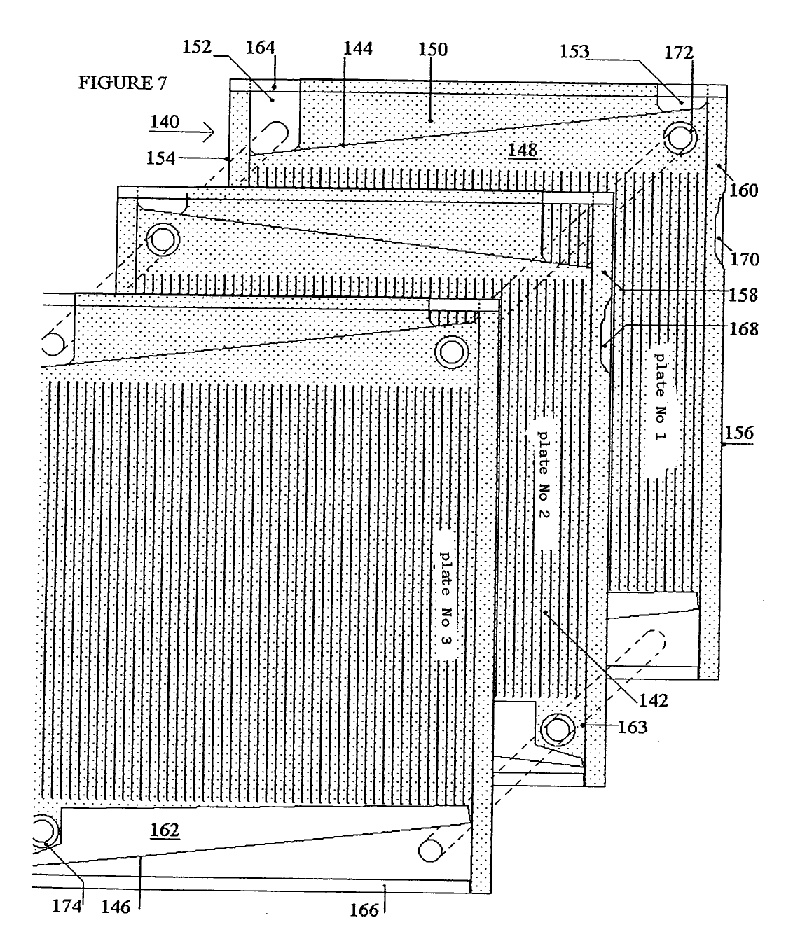

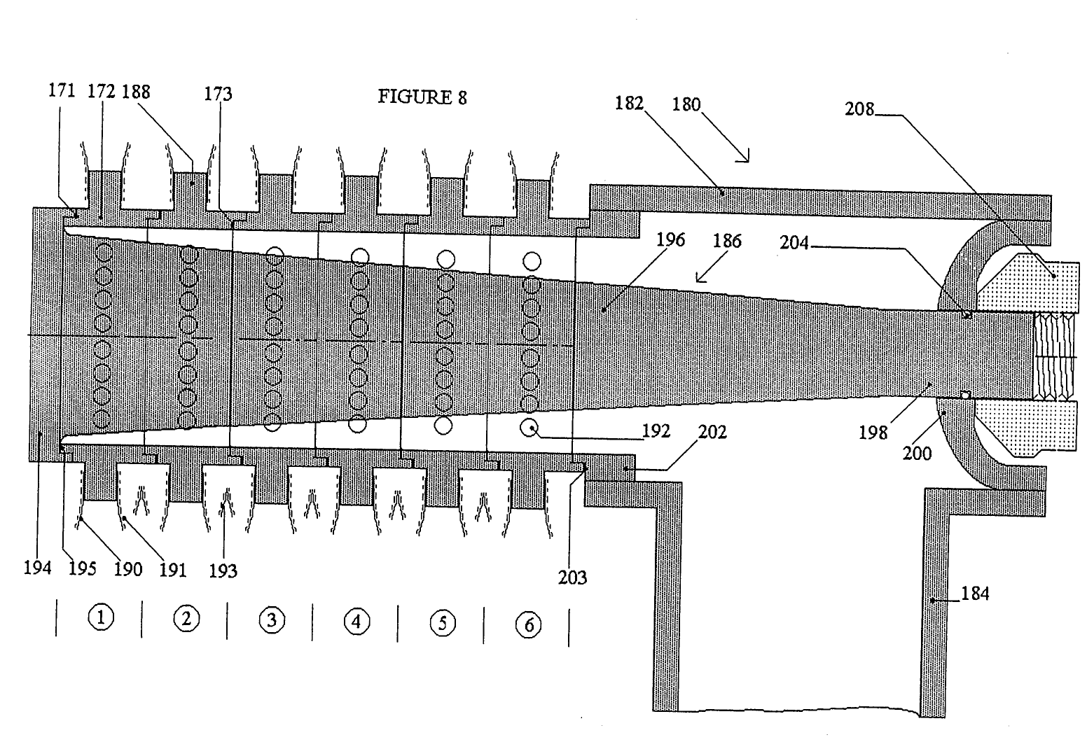

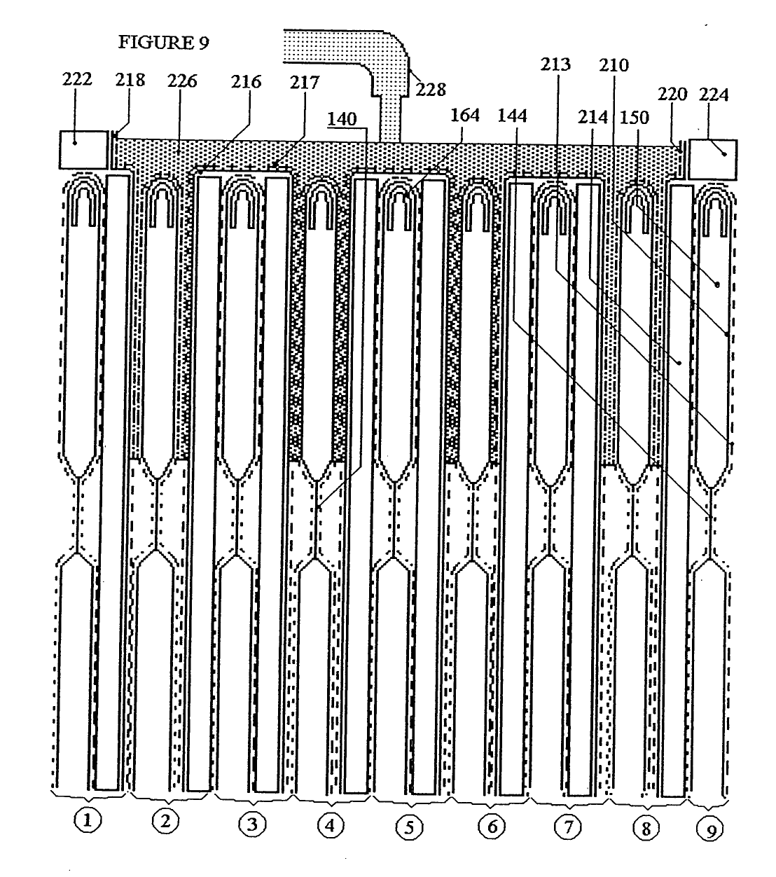

FIG. 7 represents diagrammatically three large, flexible hollow plates, provided with their frame and their coupling washers. FIG. 8 represents a longitudinal cross-section of one of the four feed devices of a large number (6, in the drawing) of large hollow, rectangular plates, odd or even in number, ensuring heat exchanges in a still, according to the invention, which operates with a heat-transfer fluid liquid. As regards FIG. 9, it represents the device ensuring the distribution of the hot liquid to be distilled, over the hydrophilic coatings only of the plates assigned to the evaporation of this liquid, when the heat-transfer fluid is a liquid.

According to FIG. 7, each flexible rectangular plate 140_{1,2,3} which measures, for example, 120 cm in height and 100 cm in width is made from a thin sheet (in particular of polypropylene), provided with a welded hydrophilic coating (in particular, a cellulose non-woven, represented in dots), folded in two, the fold constituting the upper edge of each plate.

When the plates 140_{1,2,3} are of the flexible type, sets of parallel weld lines (up to 50) are formed, which define the internal ducts 140_{1,2,3} of these plates, which are for example 15 to 20 mm in width and 80 cm in length. At the top and at the bottom of these sets of parallel ducts 141₁142_{1,2,3}, two oblique weld lines 141₁144_{1,2,3}, et 146_{1,2,3}, inclined and parallel, are produced, which define a top common channel 148_{1,2,3}, and a bottom common channel 163_{1,2,3} respectively, both trapezoid in shape. The part of each plate 140_{1,2,3} situated above the oblique line 144_{1,2,3}, constitutes a sleeve 150_{1,2,3}, the two ends of which are cut, in order to provide one large and one small cutout 152_{1,2,3} and 153_{1,2,3}. On both sides of the sets 142_{1,2,3} of parallel lines, two weld lines 154_{1,2,3} and 156_{1,2,3}, are produced parallel to the preceding ones, which constitute the external edges of each plate 140_{1,2,3}. These same lines 154-156, in cooperation with the external line, extended by its two ends, which borders the first and the last duct of each plate, delimit two vertical sleeves 158_{1,2,3} and 160_{1,2,3}, approximately 4 cm in width, over the whole height of the elements. Such flexible plates possess corrugated walls.

The two slopes of wall 162_{1,2,3}, situated below the low oblique line 146_{1,2,3} of each plate, are folded upwards in order to constitute, with the external wall of its common low channel 163_{1,2,3}, two collecting liners for the liquids which have seeped into the hydrophilic coatings of the two walls of the plates 140_{1,2,3}. A trough (not shown) is arranged under the bottom ends of the two collecting liners of each plate, so that, because of the opposite orientations of the collecting liners of two contiguous plates, one of the troughs will collect the liquid which flows off the odd-numbered cold plates and the other, that from the even-numbered hot plates.

Each plate 140_{1,2,3} has a semi-rigid frame which comprises two horizontal rods and two vertical strips, both made of steel, for example, or of a reinforced polymer with high mechanical strength. The rods have a U-shaped cross-section, the top one 164_{1,2,3} an inverted U, for the suspension of the plate and the other bottom one 166_{1,2,3} a U the right way up, to give it a longitudinal pressure and complete the frame. By way of example, the external thickness of these rods is 3 mm, their height 10 mm and their wall thickness 1 mm. The ends of these rods comprise, set back over their sides, two cusps (not shown). The openings of the inverted-U rods 164_{1,2,3} are engaged on the ends of vertical strips 168_{1,2,3} and 170_{1,2,3}, with rounded edges, 3.5 cm wide and 1 mm thick. The gap between these strips is imposed by that between the stops constituted by the cusps of the rods. The rods 164_{1,2,3} as well as the strips 168_{1,2,3} and 170_{1,2,3} are respectively engaged in the horizontal 150_{1,2,3} and vertical sleeves 158_{1,2,3} and 160_{1,2,3}. The distance between these strips, which is held fixed by the U-shaped rods 164, 166, determines the initial transversal pressure of the flexible plates 140_{1,2,3}.

Should rigid cellular panels be used in place of the flexible plates, thin sheets with a hydrophilic coating, identical to those used for the flexible plates, are previously glued then welded onto these panels, by weld lines similar to, but more widely spaced than, those producing the sets of ducts 142_{1,2,3}, in order to ensure the reliability of the assembly thus constituted. This welding operation is more or less identical to that carried out in order to produce the flexible plates, which consists of pressing the elements to be welded, for a few seconds, between two thick metallic trays, provided with surfaces which are straightened then machined according to the weld lines to be produced, these trays being taken to an appropriate temperature, defined by the melting point of the polymer used. In the two cases, the edges of the sleeves of the rods and of the strips are welded whilst the edges of the cutouts at the ends of the horizontal sleeves and the exact positions of the connecting washers, presented hereafter, are marked to be put into place in a subsequent stage of the method of production of flexible or rigid plates. Each plate 140_{1,2,3} comprises, in the diagonally opposite wide corners of its common top 148_{1,2,3} and bottom channels 163_{1,2,3}, washers 172_{1,2,3} and 174_{1,2,3} for feeding through these common channels. These washers and these common channels cooperate in order to ensure the distribution or the recovery of the heat-transfer fluid entering or exiting from these ducts. The dotted lines which link these washers in FIG. 7, represent the positioning of the odd- or even-numbered sets of feed devices (illustrated in FIG. 8), which pass through the wide cutouts 152_{1,2,3} of the sleeves 150_{1,2,3}. Such rigid cellular plates possess plane walls.

According to FIG. 8, the feed device of six even or odd hollow plates comprises a stack of six washers 172₁₋₆, associated with a T-shaped coupling 180, comprising a first tube 182, coaxial with these washers, and a second at a right angle, 184. This stack and this coupling are held in place by a tie rod 186. Each of the washers 172₁₋₆ is a ring measuring, for example, approximately 17 mm in thickness and 4 cm internal diameter, in the case of hollow plates of one m² provided for a still with counter-current of water. Each ring is provided, in its central part, with a circular flange 188₁₋₆, the side faces of which are welded to the internal faces of the walls 190₁₋₆ and 191₁₋₆ of a plate 140₁₋₆, 4 (see FIG. 5) and the thickness of which is more or less equal to the internal thickness of these plates, i.e. approximately 2 to 3 mm. The downstream edge of the ring of each washer 172₁₋₆ comprises an external shoulder 171₁₋₆ and its upstream edge, an internal shoulder 173₁₋₆. The circular flange 188₁₋₆ of each washer 172₁₋₆ has several horizontal holes 192, 3.5 to 4 mm in diameter (8 holes, according to the drawing) which, on the one hand, open inside the washer and on the other, inside and in the lengthwise direction of the common trapezoid-shaped channel 148₁₋₆ (see FIG. 5) which feeds the sets of ducts 142₁₋₆ of a plate 140₁₋₆.

The tie rod 186 comprises (1) a support base 194, provided with an internal shoulder 195, suitable for cooperating with the external shoulder 171, of the downstream washer 172₁, (2) a tapered rod 196, the length of which is determined by the number of washers 172 to be stacked (a hundred, if appropriate) and (3) a threaded cylindrical end 198. The tube 182 of the coupling 180 comprises, welded and/or glued at its two ends, supports respectively constituted by a cup 200, with a hole through its centre and a ring 202, provided with an external shoulder 203, suitable for cooperating with the internal shoulder 173₆ of the upstream washer 172₆. The support cup 200 is suitable for sliding on the end 198 of the tie rod 186. This end 198 comprises a housing for an O-ring 204. A nut 208, engaged on the threaded end 198 of the tie rod 186, makes it possible to keep the washers 172₁₋₆ clamped and transform their stack into a leak-free duct, for feeding the hollow plates 140₁₋₆. Between the internal faces 191_{1,3,5} and 190_{2,4,6} of the walls of contiguous plates, which are welded to the circular flanges 188₁₋₆ of the washers 172₁₋₆ the high ends of the weld lines 144 (see FIG. 7) of the intercalated odd plates appear as 193₁₋₆₅, in FIG. 8.

FIG. 9 represents, in cross-section, the top part of a set of nine flexible plates, comprising five odd-numbered cold plates 140_{1,3.,5,7,9} and four even-numbered hot plates 140_{2,4,6,8}, arranged alternating in a vapour-diffusion still, using the liquid to be distilled as heat-transfer fluid. These flexible plates are suspended from nine rods shaped as an inverted U 164₁₋₉, engaged in trapezoid-shaped sleeves 150₁₋₉, delimited by oblique weld lines 144₁₋ₛ₉. In this FIG. 9, the thin walls 210₁₋₉, made of polymer (in particular of polypropylene) of the plates 140₁₋₉ as well as their hydrophilic coatings 212₁₋₉, can be seen clearly. Between two contiguous plates, such as 140₁ and 140₂ or 140₈ and 140₉, inserts 214₁₋₈₆, preferably cellular, are arranged which go down to the top of the sets of ducts 142₁₋₉ (see FIG. 7) of the plates 140₁₋₉. The length of these inserts 214_{1-8 9} equals the maximum width of the sleeves 150₁₋₉ of the suspension rods 164_{1,9} of the plates 140_{1,9}. The upper portion of each of the cold plates 140_{3,5,7,9} as well as the two inserts, such as 214₂ and 214₃, which border them, is covered with an impermeable cover, such as 216_{3,5,7} which goes down to the lower edge of these inserts. This impermeable cover is produced by means of an impermeable sheet with a hydrophilic coating, identical to the material constituting the flexible plates, its hydrophilic coating 217_{3,5,7} being in contact with that 212_{2,4,6,8} of the even-numbered plates 140_{2,4,6,.8}. The end inserts 214₁ and 214₈, of a set of plates 140₁₋₉, are separated from the plate 140₂ for the one and from the plate 140₈ for the other, by an impermeable sheet with a hydrophilic coating 218 and 220. These sheets cooperate with two strips 222 and 224, serving as support stops, in order to constitute the impermeable edges of a hydrophilic mat 226, in contact with the upper portion of the hydrophilic coating of each of the hot plates 140_{2,4,6,8} and of the hydrophilic coating of the protective covers 216_{3,5,7} of the cold plates. This hydrophilic mat 226 is, for example, constituted by several layers of cotton fabric. Above this mat, spouts, such as 228, are installed from place to place, suitable for pouring over it the hot liquid to be distilled. Between the slopes 162₁₋₉ which form the collecting liners of the liquids which flow from the external walls of the plates 140₁₋₉, (see FIG. 7) inserts (not shown) are arranged, identical to those 214₁₋₈ placed between the tops of these same plates. In order to constitute a still, the compact unit formed by the assembly of N hollow plates 140_{1-N} is kept confined, by conventional clamping means, not shown, arranged around it.

By means of the arrangements according to FIGS. 7, 8 and 9 presented above, the hollow distillation plates of the vapour-diffusion stills according to FIGS. 3 and 4 operate under the best conditions (the case of the hollow distillation plates of a still, according to FIGS. 5 and 6, will be dealt with in detail hereafter, in comments on FIG. 13). Under the pressure of the heat-transfer liquid, the ducts of a flexible plate, as well as the common channels for distribution and recovery of this heat-transfer liquid in flexible or rigid plates, retain the correct thicknesses. Thanks to the lateral vertical strips, with fixed spacing, the ducts of the flexible plates can only have a limited internal thickness, of approximately 2 to 3 mm, in response to the pressure exerted by the heat-transfer liquid which circulates in them. Moreover, thanks to the inserts and clamping means referred to above, the top 148 and bottom 163 common channels are themselves preventing from collapsing under this same pressure. Under these conditions, the thickness of the free space between the plates 140 is kept at a correct value, namely approximately 5 mm.

As regards the pitch of assembly of these plates 140, it is equal to half the distance separating the internal and external shoulders of the coupling washers 172₁₋₆₉, i.e. 8.5 mm. As regards these washers, It will be noted that under the action of the tie rod 186, they are stacked tightly, making a leak-free line, of adjustable length. Moreover, the holes 192 make it possible, without appreciable loss of charge, to cause the heat-transfer fluid to enter into or exit from the top or bottom common channels of each hollow plate.

Thanks to the arrangements according to FIG. 9, in a still with heat-transfer liquid, the coatings of the hot plates, assigned to the evaporation of the hot evaporation liquid to be distilled, are the only ones to be capable of being wet by this liquid. In fact, thanks to the impermeable covers 216 covering the tops of the cold plates as well as their two associated separation inserts 214, the hot liquid to be distilled cannot reach them, whilst, under the action of the hydrophilic coating of these same covers, this hot liquid, which passes through the hydrophilic distribution mat 226 is brought, by gravity and capillarity, as far as the hydrophilic coatings of the set of hot plates.

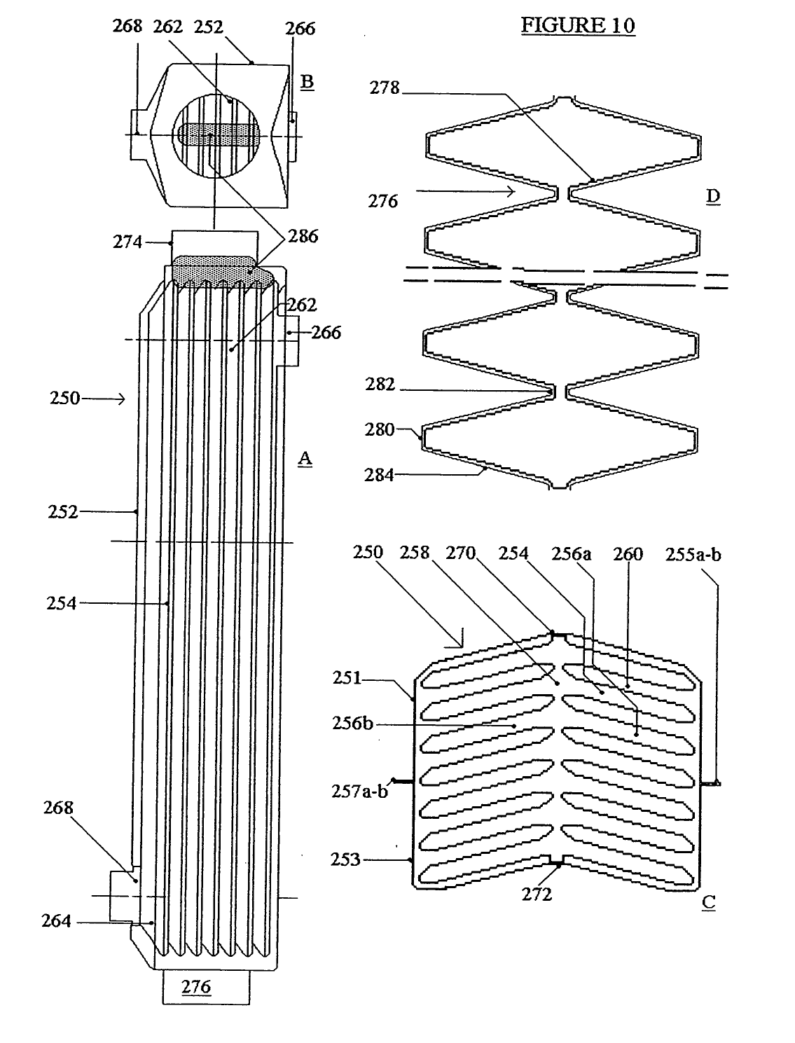

FIG. 10 represents in A and B, profile and top views of a compact, low-cost heat exchanger and in C and D, cross-sections of this exchanger and of the blank of its monobloc active element. According to FIGS. 10A and 10C, the compact heat exchanger 250 comprises a casing 252 which completely surrounds an active exchange element 254. This active element 254 is constituted by the stacking of a relatively high number (up to thirty, for example) of pairs of hollow plates 256 a-b, at the same time elongated, symmetrical and connecting. According to the section 10C, the cross-section of the active element 254 is in the form of a fish's vertebral column, provided with hollow ribs 256 a-b, oblique and parallel to each other, which share a common central channel 258. The internal thickness of these ribs 256, and the distance separating them 260 and their common central channel 258 is small and more or less identical (2 mm, for example). The thickness of the walls of the active element 254 is thin (0.5 mm, for example).

Each hollow plate 256 a-b of the active element 254 comprises a rectilinear central part the length of which can vary from approximately 30 to 100 cm and the width from approximately 5 to 15 cm. A hollow plate 256a is connected to its symmetrical plate 256b by two couplings with hollow ends 262-264, in the form of truncated semi-cones. The stacking axes of these truncated semi-cones coincide with the axes of the two lines which feed the different pairs of stacked hollow plates 256 a-b and they end in the two coupling tubes 266-268 of the active element 254.

The casing 252 is represented transparent for the needs of the drawing of FIG. 10A. It is formed of two half-shells 251-253, with respectively convex and concave bases, assembled in tight fashion (welding, gluing or sealing device) by their assembly flanges 255 a-b and 257 a-b.

The gap between the casing 252 and the edges of the plates 256 of the active element 254 is small (1 mm, for example) but it is zero along the crest 270 of its convex wall and along the hollow 272 of its concave wall. The casing 252 possesses two coaxial coupling tubes 274-276 and two side openings through which the coupling tubes 266-268 of the active element 254 pass, the edges of these openings being welded, glued or assembled with a sealing device, at the root of these two tubes 266-268.

FIG. 10D represents the cross-section of the blow-moulded blank 276, from which the active heat exchange element 254 has been produced. This blank 276 comprises a stack of relatively long biconvex bellows 278, provided with relatively short end couplings (see FIG. 10A) in the form of symmetrical truncated semi-cones. The stack of the bellows 278 is comparable to an accordion the bellows of which would have levelled-off crests 280 and narrow bases 282, with sufficiently great depths of bellows before the large diameter of the end semi-cones, to allow the latter to constitute turned-over surfaces, involving a transition buckling when turned over. The transformation of the blank 276 into an active element 254 is carried out under the action of a controlled axial compression force. This force has the effect of causing each of the two symmetrical sides of each convex semi-bellow to pass from one stable state to another, becoming parallel to one of the two symmetrical sides of each concave semi-bellow which is associated with it. In the case of an active element made of glass, the transformation of the bellows from the blank into small parallel plates takes place at a particular temperature, giving the glass used an appropriate flexibility and elasticity. It will be noted that the flattening of the bellows of such blanks made of polymer or glass can be done without the tilting of one of the walls of the hollow end couplings and that an efficient monobloc heat exchanger is however produced, as taught in the PCT Application concerned, referred to above.

The blank 276 makes it possible to produce a standard active heat exchange element. For a heat exchanger having to evaporate the liquid to be distilled, in accordance with said prior invention, the walls of a blank 276 made of polymer are provided with a thin hydrophilic coating 284, preferably preformed, having a thickness of for example 0.1 mm. In this case, the blank 276 is, once again, produced by blow-moulding of a sleeve made of pasty polymer, flattened in shape, produced by an extruder, then introduced into a mould comprising multiple parallel grooves, previously provided with the coating 284. In the case of an active element made of glass, the process for producing the blank is more or less identical to that used for the polymers. As regards the chemical treatment intended to give a dull finish to the internal and external faces of such an element made of glass, in order to make them wettable, this is carried out according to a technique which is perfectly familiar to glass makers. The coatings 284 (or the dull-finished faces) of the pairs of plates 254 of the active element 250, are associated with a common layer of hydrophilic fabric 286, which covers all the top end couplings 262 of this element (it is vertical in a still according to the invention). This common hydrophilic layer 286 is intended to uniformly distribute, over the coatings 284 of the plates 254, the liquid to be distilled which is introduced into the casing 252, through its top tube 274.

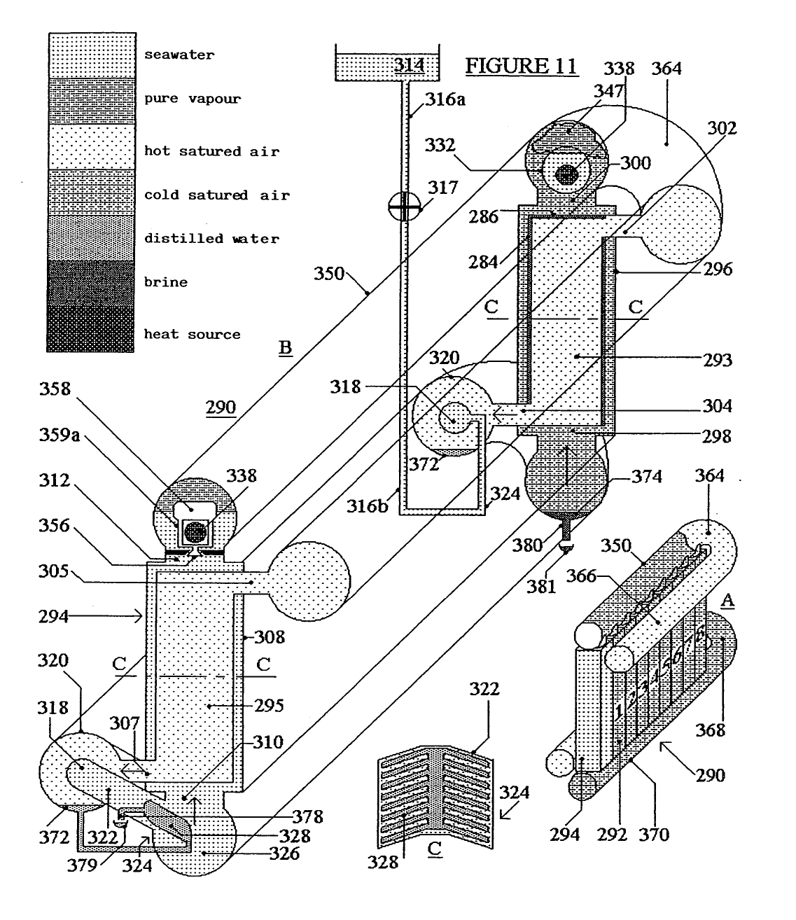

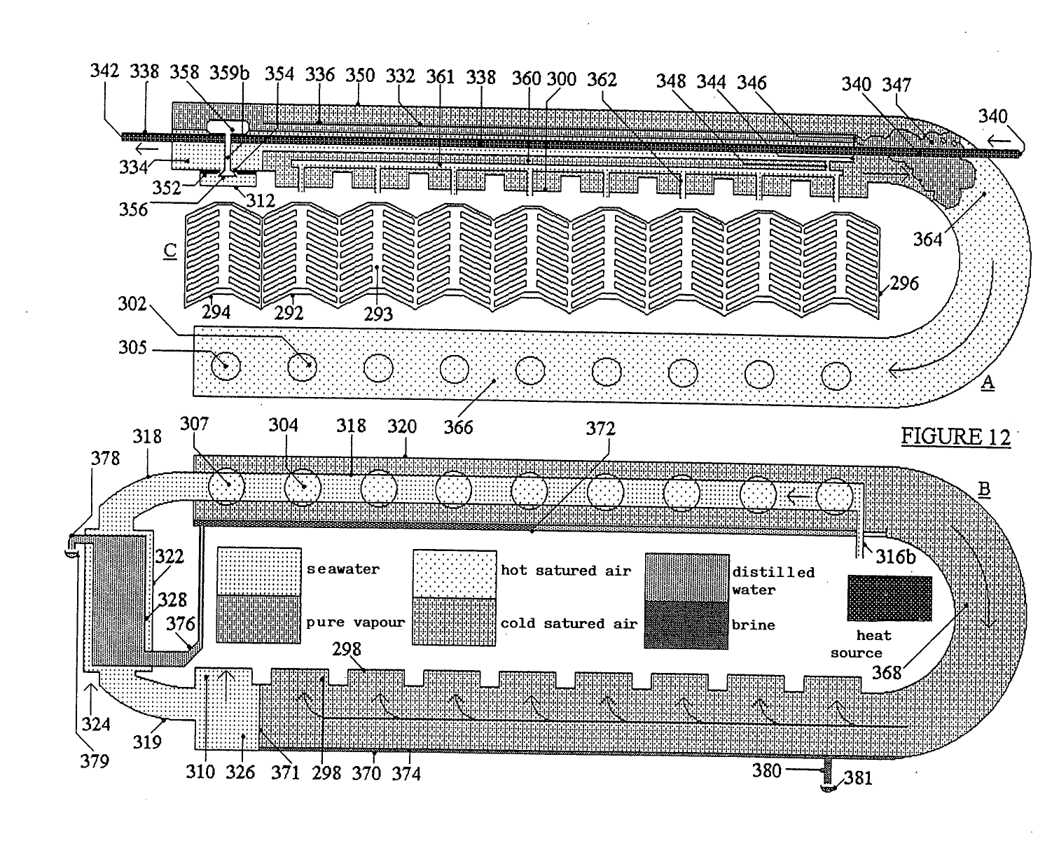

FIGS. 11 and 12 relate to a particular embodiment of a vapour-diffusion still module using a non-condensable gas saturated with vapour of the liquid to be distilled as heat-transfer fluid and compact distillation heat exchangers of the type described in FIGS. 10A,B,C. FIG. 11A is an overall view of such a module.

FIG. 11B represents the details of this module and FIG. 11C, a cross-section of one of the heat exchangers used. As regards FIGS. 12A,B, they represent the details of the pipes and couplings of the different fluids which circulate in the still.

According to FIGS. 11A,B, the still 290, presented as an example, is a module comprising firstly (1) eight compact distillation heat exchangers, vertically arranged, 292₁₋₈, intended to ensure evaporation of the liquid to be distilled then condensation of its vapour, and (2) a simple compact heat exchanger 294. According to FIG. 12C, which is the section according to the plane C-C of FIG. 11B, the active element 293₁₋₈ of each compact exchanger 272₁₋₈ comprises eight pairs of symmetrical, integral, thin, small hollow plates. According to FIG. 11B, these pairs of plates are provided with a hydrophilic or wettable coating 284₁₋₈ and with a cover made of hydrophilic fabric 286₁₋₈, ensuring a uniform distribution of the liquid to be distilled over all the coatings 284₁₋₈.

In this example of a still 290, each plate of the eight symmetrical pairs of an active element 293₁₋₈ has a width of 10 cm, a length of 60 cm, an internal thickness of 2 mm, a wall thickness of 0.5 mm, a coating thickness of 0.1 mm and separation gaps of 2 mm. The surface area of each active element 2931-8 is approximately 1 m² and its total volume 2.5 dm³. The active volume V of a module of eight elements is 20 dm³ and its total heat exchange surface area 8 m².

According to FIG. 12C, the eight active elements 293₁₋₈ with vapour diffusion are combined in a single casing 296 but they could just as well be isolated or combined two by two or four by four in smaller casings. In any case, each active element 293₁₋₈ is associated with two coaxial inlet 298₁₋₈ and outlet 300₁₋₈ ports, provided in the part of the casing which surrounds it. According to FIGS. 11B and 12A,B, each active element 293₁₋₈ with vapour diffusion comprises, in its top part, a lateral inlet port 302₁₋₈ and, in its bottom part, a lateral outlet port 304₁₋₈, diagonally opposite the preceding one. Similarly, the simple heat exchanger 294 comprises an active element 295, provided with lateral inlet and outlet ports 305, 307 and a casing 308, provided with two coaxial inlet and outlet ports 310, 312.

Above the still 290, a seawater reservoir 314 is installed, linked by a tube 316a-b and a valve 317, to a duct 318 which passes through a tube 320, into which the eight outlet ports 304₁₋₈ of the active elements 293₁₋₈ with vapour diffusion and the outlet port 307 of the active element 295 of the simple heat exchanger 294 open. The duct 318 is linked to the inlet to the casing 322 of a counter-current heat exchanger 324 and the outlet from this casing is connected, by a tube 319, to an antechamber 326, preceding the inlet port 310 of the casing 308 of the simple compact exchanger 294. This exchanger 324 is the subject, in FIG. 11B, of a symbolic representation but, in FIG. 12, its representation conforms more closely to reality. This heat exchanger 324 is of the compact type and it comprises an active element 328, the cross-section of which is represented in FIG. 11C. The function of this element 328 is described in detail hereafter. The seawater which exits from the exchanger 324 passes through the heat exchanger 294 then exits from it, by its outlet port 312, to enter a boiler 332.

According to FIG. 12A, the boiler 332 comprises an inlet part 334, extended by a heating tube 336, itself passed through by a tubular radiator 338. This radiator 338 possesses an inlet 340 and an outlet 342, both external to the boiler 332, and it is suitable for an appropriate heating fluid (hot gas or liquid from 105 to 120° C.) to pass through without damaging it. To this end, the radiator 338 can be made of a metal, suitable for resisting possible corrosion by the heating gas used, or of a polymer having good mechanical resistance to the temperature of the hot liquid. The heating tube 336 comprises at its downstream end (1) a dividing wall 344, passed through by the tubular radiator 338, (2) in the top part of this dividing wall 344, one or more calibrated orifices 346, suitable for engendering one or more vapour jets 347, when the seawater arrives in this heating tube 336 and (3) in the bottom part of this same tube 336, one or more holes associated with one or more short tubes 348, with calibrated section, suitable for ensuring an appropriate withdrawal of this water.

The boiler 332 is enclosed in an elongated cylindrical duct 350, with a circular section, arranged horizontally, and the outlet ports 312 and 300₁₋₈ of the casings 308 and 296 of the heat exchangers 294 and 292₁₋₈ open into the bottom part of this duct. The inlet part 334 of this boiler occupies the upstream end of the duct 350 and it comprises, slightly after the outlet port 312 of the casing 308 of the exchanger 294, a thick dividing wall 352, with a truncated-cone-shaped opening 354 made in its centre, occupied by a closing device 356 with an identical profile, suitable for progressively closing this opening when it is pulled upwards. The closing device 356 is linked to a float 358 by two linking rods 359a-b, between which the downstream end of a tubular radiator 338 passes. When the seawater reaches an appropriate level in the inlet part 334 and in the heating tube 336 of the boiler 332, the float 358 brings the needle-valve closing device 356 to completely close the inlet opening 354 of the boiler, which thus operates at a constant level of seawater, situated above the tubular radiator 338. In the bottom part of the duct 350, under the heating tube 336 of the boiler 332, a chamber 360 for superheating and supersaturation of the heat-transfer gas is installed, occupied by a narrow and slightly hollow tray, covered with several layers of hydrophilic fabric 361. The seawater exiting from the heating tube 336 of the boiler 332 by the calibrated extraction tube 348, flows over the downstream end of the tray and soaks the whole of the hydrophilic fabric 361. In turn, this tray has eight calibrated holes, situated just above the eight outlet ports 300₁₋₈ of the casing 296 of the active elements 293₁₋₈ with vapour diffusion. A wick and/or a tube 362₁₋₈ engaged in each of the holes through the tray and in each of the outlet ports 300₁₋₈ of the casing 296, establish a link between the hydrophilic coating 361 of the tray and the hydrophilic cover 286₁₋₈ of the end couplings 274 (see FIG. 10A) of the active elements 293₁₋₈.

The horizontal cylindrical duct 350, surrounding the heating tube 336 of the boiler 332, is linked by a bent tube 364 to another horizontal cylindrical duct 366. The inlet ports 302₁₋₈ of the active elements with vapour diffusion 293₁₋₈ and the inlet port 305 of the active element 295 of the simple heat exchanger 294, open into this duct 366, whilst the outlet ports 304₁₋₈ and 307 of these same active elements open into the duct 320. This duct 320 is linked by a bent tube 368 to another horizontal cylindrical duct 370, into which the inlet ports 298₁₋₈ of the casing 296 of the active elements 293₁₋₈ open. The duct 370 comprises, at its downstream end, a dividing wall 371 which separates it from the antechamber 330 of the casing 308 of the simple heat exchanger 294, the external wall of this antechamber extending that of the duct 370.

The distilled water which flows from the outlet ports 304₁₋₈ and 307 of the active elements 293₁₋₈ and 295 and that which has condensed on the external wall of the tube 318 passed through by the cold seawater accumulates at the base 372 of the horizontal duct 320. The salt water which flows from the heat-transfer-gas inlet ports 298₁₋₈ of the casing 296 accumulates on the base 374 of the horizontal duct 370. This base 372 is linked to the inlet to the active element 328 of the exchanger 324 (see FIG. 12B), by a tube 376. The outlet from this active element 328 opens into a tube 378 and a drainage trough 379 of the distilled water, whilst the salt water which accumulates at the base 374 of the duct 370 is removed by a tube 380 and a trough 381.

Thanks to the embodiments given to the still according to the invention and to the boilers capable of feeding it, described in FIGS. 11 and 12 commented on above, we have particularly useful distillation devices, with vapour diffusion and heat-transfer gas. The general functioning of the still described in FIGS. 11-12, is identical to that of the still, according to the third embodiment of the invention described in FIG. 5, which has been described in detail above. The N hollow distillation plates 54 are replaced by the eight compact exchangers with vapour diffusion 292 and the n auxiliary reheating plates, represented by the tube 66, replaced by the simple heat exchanger 294. The active element 84, passed through by cold water to be distilled, of the heat exchanger 80, replaced by the duct 318 similarly passed through, the casing 82 being replaced by the horizontal tube 320 and the exchanger 88 is replaced by the exchanger 324. The trough 379 for removing the distilled water which has accumulated at the base 372 of the tube 320, which has condensed in the exchangers 292₁₋₈ and 294 and in the tube 320, and which exits from the active element 328, replaces the trough 116 into which flows the distilled water collected at the outlet from the (N+n) plates 54, 63-66, at the base of the casing 82 and at the outlet from the active element 114. But the economic advantage of this second way of producing a still with vapour diffusion and heat-transfer gas, improved according to the present invention, is on the other hand much greater than that of the first, represented in FIG. 5. This superiority is due firstly to the form given to the heat exchangers used, and secondly to the means implemented for circulating the heat-transfer gas in these exchangers.

It will be noted that the heat exchanger 80 or that constituted by the tube 318 and its casing 320 is an essential component of the still with vapour diffusion and heat-transfer gas, according to the present invention. Its function is to reduce the temperature of the heat-transfer gas exiting from the hollow plates by several tens of degrees, before causing it to enter the inter-plate spaces. This is in order to have, at the inlet to the inter-plate spaces, a local difference dH in enthalpy flows more or less equal to that engendered by the heat source between the outlet from these spaces and the inlets to the hollow plates, given the very large difference which exists between the apparent calorific capacities Cₚ of the saturated air at the temperatures concerned. On the other hand, it appears that the heat exchangers 88 and 324 have the objective of recovering the thermal energy from the distilled water to be removed, in order to optimize the C_{OP} of the still. In fact, the liquid to be distilled, entering the inter-plate spaces of the compact heat exchangers 294, exits from one or more other heat exchangers 324 of the same type, arranged between the outlet or outlets from the heat exchangers 292-294 and the means 376 for collecting the distilled liquids which condense on the internal faces of the active elements of the heat exchangers 292 and 294 and on the walls of the duct 318 of the heat exchanger 318-320 or of its equivalents 250. Doing away with these exchangers 88 and 324, in the case of an inexpensive thermal energy, has scarcely any significance. The same practically applies to the n auxiliary hollow plates, represented by the tube 66 and its casing 63, or by the exchanger 294, producing an additional heat exchanger between the hot saturated heat-transfer gas and the liquid to be distilled, before the latter enters the heating chamber of the boiler 120 or 332.

To the advantages which can be attributed to the only compact exchangers used in the second still, will be added the use of one or more simple vapour jets for causing the heat-transfer gas to circulate. These vapour jets 347 are suitable for reheating to an optimum or simply efficient temperature T₁ and supersaturating the flow of heat-transfer air, which leaves downstream of the spongy mat 361 which is soaked with very hot water. Moreover these vapour jets provide this flow of air, by exchange of quantities of movement, with a sufficient pressure, to cause it to enter at the top and drop down inside the active elements 293 of the exchangers 292 and thus cause it to flow, opposite natural convection, in a looped circuit, through the hollow plates 256 of the active elements 293 and their inter-plate spaces 260. By way of example, such a quantity of movement, capable of propelling a hot flow of air from the top of thin hollow plates downwards, then this same flow, cooled down, from the bottom of narrow inter-plate spaces upwards, overcoming the different losses of charge experienced during such a passage in a closed loop, can be obtained by taking to 102° C. the seawater in the heating tube 336, which will engender one or more relatively powerful vapour jets, with 80 millibars of overpressure, ejected at 150 m/s. Such vapour jets make it possible to overcome natural convection and also to do away with the ventilator 92, provided for this purpose in the still in FIG. 5. This has the consequence of also reducing the amount of investment to be carried out and appreciably simplifying the use of the equipment.

The added advantages provided by the presence (1) of the float linked to the needle-valve closing device installed at the inlet to the heating tube of the boiler represented in FIG. 12A and (2) of the two groups of calibrated outlet holes, at the top and bottom respectively, made at the outlet from this heating tube, to allow the production of vapour jets and the extraction of the hot water, will be noted. Thanks to these components of the boiler, there is a heating tube with a constant level, pressure and flow. In fact, it is possible, by means of a flow of any sufficiently hot, gas or liquid, heating fluid, to take the seawater to be distilled, contained in this heating tube, to a temperature above its boiling temperature and thus to create, above the level of the water, a vapour under overpressure. The amplitude of this overpressure is determined by the heating power used. The heating tube 336 and the tubular radiator 338 constitute a heat exchanger for fluids confined in counter-current circulation. The characteristics of this exchanger (materials, diameters and lengths of the heating tube and of the tubular radiator), are determined as a function of the results to be obtained, given the respective characteristics (natures, flow rates, temperatures, calorific capacities) of the heating fluid available and of the liquid to be distilled. Such a production of vapour is obtained, for example, by means of a tubular radiator made of appropriate stainless steel, capable of resisting the different components of diesel-engine exhaust gas at 300° C. Should the heat-transfer fluid to be used be the cooling liquid (at approximately 110° C.) of a heat engine, the material used can be the same for both, (a polymer which is mechanically stable at these temperatures, for example). The same would apply if the heating liquid of the tubular radiator were thermal oil (of the type ESSO 500, for example) heated during the day by an appropriate solar boiler, equipped with a cylindrical parabolic reflector, and stored day and night at a high temperature (120 or 130° C., for example) and at atmospheric pressure, in a heat-insulated reservoir.

When the boiler is stopped, the total pressure above the level of water in the heating tube is equal to the external pressure, and the flow of water through the extraction tubes is practically zero. When the boiler is in operation and an equilibrium temperature is reached (102° C., for example), the overpressure above the level of water is 80 millibar and the flow rates of water and of vapour are at their nominal values. The transition between these two states is very short since only the quantity of water present in the heating tube is to be heated. Any variation in the heating power leads to a variation in the temperature of the water and in the equilibrium pressure of the vapour in the heating tube. Consequently, any increase in the power of the heating power leads to a simultaneous increase in the flow of vapour and in the flow of water to be evaporated in the still, which can therefore comprise only a single control and therefore render the valve for adjusting the flow of salt water entering unnecessary.

In FIG. 5, the embodiment of the boiler 120 has not been specified. In practice, it is possible to use one or other of the boilers described in FIGS. 11 and 12. It will be noted that the temperature of the water that it supplies is below its boiling temperature. In the absence of vapour under overpressure, the vapour jet 347, used in FIG. 12 to cause the heat-transfer gas to circulate, cannot therefore be created by the boiler 120. Consequently, a mechanical means of propulsion, a ventilator 92, must be used to cause this gas to circulate. The case of a boiler incapable of producing vapour under overpressure is, for example, that of a solar boiler without a reflector.

FIG. 13 represents a perspective view of a still with vapour diffusion and heat-transfer gas circulating by natural convection, the distillation unit of which is a set of plane and flexible, thin hollow plates, of a model particularly well suited to this type of still. In fact, this FIG. 13 describes in detail the production of a still according to FIG. 6, in which the solar boiler is replaced by a heating tube.

FIG. 13 shows six thin hollow plates 400₁₋₆ which symbolically represent a distillation unit constituted by a large number of these same plates (several hundred or even several thousand, if appropriate) which can be installed on a framework (not shown) mounted in a heat-insulated treatment chamber 401. This chamber 401, like the chamber 48′ in FIG. 6, comprises three stages having approximately the same height: a lower stage for the bottom vent, a central stage for the distillation unit and an upper stage for the top vent. In FIG. 13, in order to facilitate the description and simplify the drawing, several walls of this chamber 401 are represented by their contours only.

By way of non-limitative example, each hollow plate 400 measures 40 cm in width, 50 cm in height and 2 mm in internal thickness. Generally however, such plane, flexible and thin hollow plates, can have a maximum surface area per face of approximately 1 m², a maximum width of approximately 80 cm and internal thickness of 5 mm at the most. Each plate 400 is formed from a fine fleece 402₁₋₆ made of polymer (in particular of polypropylene) having a good mechanical resistance to the maximum temperature (at the most 90° C.) of the heat-transfer gas. This fleece, identical to that used for producing the large plates 140 in FIG. 7, has a thickness of approximately 100 to 250 microns and it is provided with a hydrophilic or wettable coating of approximately 50 to 150 microns in thickness. In FIG. 13, each fleece 402₁₋₆ appears folded in two, carried by a suspension rod 404₁₋₆, coating on the outside. The rods 4041-6 are made of polymer, with a rounded upper edge, and they are 2 mm in thickness, 4 cm in width and 50 cm in length. By means of one or more longitudinal weld lines, the top part of each fleece 402₁₋₆ is welded to its suspension rod 404₁₋₆, and its bottom part similarly welded to a tension bar 406₁₋₆. The rods 404₁₋₆ and the bars 406₁₋₆ are made of polymer identical to that of the fleece and they are all 2 mm in thickness and of 50 cm in length. The pressure bars 406 comprise at their ends supports 408a-b with co-planar upper edges. Between these two supports, through the tear 405 made in the front slope of the fleece 402₁, can be seen the tension bar 406₁ which has an oblique lower edge 410, connected slantwise to the end of this bar. At the bottom of the oblique edge 410, there is provided in the thickness of each pressure bar 406, a point 412 for extraction of the distilled water produced, constituted by a transversal cut, 1 mm deep and 3 mm wide, if appropriate, replaced or occupied by a flat wick. The upper edge of each pressure bar 406 is in the form of a very open V, jammed onto the cut 412. The slopes of the fleeces 402₁₋₆ project over their tension bars 406₁₋₆. These slopes are raised and folds formed slantwise, then compressed and held in place by any appropriate means, in particular by stitches. In this way, for each hollow plate 400, two parallel and contiguous, inclined, flat ducts 414, are constituted, making it possible to collect the salt water produced by each hollow plate of the still. Under the flat ducts 414 and perpendicular to the extraction points 412 of the assembly of hollow plates 400 thus formed, a single trough 416 is installed for collecting the hot distilled water produced.

The salt water collected by the flat ducts 414 flows into a trough 418 provided with spouts 420a-b, arranged above a heating tube 422, covered with a thin hydrophilic mat 424, with clear slopes. The length of this heating tube 422 corresponds to that of the assembly of thin hollow plates 400₁₋₆, juxtaposed with inter-plate spaces 403₂₋₆ of the same thickness. The heating tube 422 is fed with heating fluid by a tube 423, this fluid being capable of taking the temperature of the salt water which impregnates the mat 424, to a maximum temperature of approximately 95° C. The tube 422 is installed in the bottom vent 426 of the still. This vent 426 is constituted between a thick panel of thermal insulation 428 which divides the lower stage of the treatment chamber 401 into two connecting parts. This panel 428 forms, with the similar panels, such as 430 (the only one shown), which constitute the insulation of the transversal walls of the lower stage of the treatment chamber 401, on the one hand, the unoccupied part 432, with a plane wall 433, of this lower stage and, on the other hand, the bottom vent 426, with a curved wall 427. Perpendicular to the heating tube 422, a reservoir 434 is arranged in which the salt water which flows hot from the mat 424 covering this heating tube 422 ends up. The hollow plates 400 are provided with a top vent 436, constituted in the same manner as the bottom vent 426. This top vent 436 opens into a passage 435, formed between a block of thermal insulation 437 and the upper wall 439 of the treatment chamber 401. In this passage 435, one or more monobloc active heat exchange elements 438 are installed, passed through, with a counter-current of the air which circulates around, by the seawater to be distilled which enters the still by a tube 440 and exits from it by a tube 442. By way of example, such a heat exchange assembly 438, possesses an air/water exchange capacity of approximately 170 Watts/° C. and, for this purpose, it comprises thirty-four bellows 15 cm long and 5 cm wide, with internal thicknesses of hollow plates and inter-plate spaces of 2 mm. Beyond the space occupied by these elements 438, can be seen the unoccupied part 443 of the upper stage of the treatment chamber 401. Above the hollow plates 400, an elongated device 444 (an open box as shown or a tube under slight pressure) for distribution of the tepid seawater introduced by the tube 442 is installed transversally. The base of the distributor 444 comprises two rows of holes, made at the pitch of assembly of the plates and passed through by spread wicks (not shown) fixed by a few clips, on top of the hydrophilic coating of these plates.

The suspension rods 404₁₋₆ of the hollow plates 400₁₋₆ are fitted on two parallel horizontal girders, forming part of the framework installed in the heat-insulated treatment chamber 401, and the pressure bars 406 of these plates under two horizontal pressure-control girders, similar and parallel to the preceding ones, connected to the framework by springs. The height of the hollow plates 400 determines the distance between these girders and the latter is fixed once for all. These girders, this framework and these springs are ordinary components which are not shown so as not to overburden the figure.

Given the elasticity of each of the fleeces 402 and the rigidity of the springs integral with the two low girders, the individual force of tension of each fleece is approximately 200 to 400 grams, as a function of the wall thickness and of the height of the fleeces.

At a distance of 5 cm from one of the ends of each of the rods 404, a short spacer 448 is fixed squarely to it. This spacer 448, which measures 22 cm in length, 2 cm in width and 2 mm in thickness, is free between the two slopes of the folded-up fleece 402, its external edge coinciding with the external edges of these two slopes. Similarly, 5 cm from the opposite end of each of the pressure bars 406, another short spacer 450 is also fixed squarely, under the same conditions, visible through the tear 451, identical to 448. Thus, at the bottom and at the top of the fleeces 402₁₋₆, folded up over their suspension rods 404₁₋₆, two diagonally opposite openings 452₁₋₆ and 454₁₋₆, 20 cm high and 2 mm wide are provided, which constitute the inlets to and the outlets from the hollow plates 400₁₋₆. These inlets and these outlets remain constantly well open and the internal thicknesses of these plates virtually constant, because of the tensions uniformly engendered in the clear slopes of the fleeces, by the springs integral with the girders resting on their pressure bars and because of additional gluing of the edges of the openings on the long spacers 456, described hereafter.

The hollow plates 400₁₋₆ are separated from each other or from the two assembly and maintenance panels referred to hereafter, by free spaces 403₁₋₇, each of these spaces being bordered by a pair of long spacers, such as 456₂, 2 mm thick and 2 cm wide, resting on the two girders of the framework. The inlets, such as 457₃, to these inter-plate spaces 403 are visible in FIG. 13 whilst their outlets are hidden. The assembly formed by the hollow plates 400₁₋₆ thus suspended and tightened, by the inter-plate spaces 403₂₋₆ and by the two free end spaces, bordered by long spacers, such as 456₂ et 456₇, is assembled by two rigid panels (not shown) linked by means of clamping tie rods. In this way, the suspension rods 404, the short spacers 448-450, the long spacers 456 and the pressure bars 406 firmly clamp the fleeces 402 which constitute the hollow plates 400, their inter-plate spaces 403 and the two free end spaces. Under these conditions, a distillation unit is constituted which has a completely sufficient lateral tightness, around the inlets 452 and outlets 454 of the hollow distillation plates 400 and, in the case of the inter-plate spaces 403, on both sides of their inlets 457 and their outlets.

The arrows 460, 462 and 464 represent the rising flow of air in the three stages of the treatment chamber 401, namely in the bottom vent 426, inside the hollow plates 400 and in the top vent 436. The arrow 466 represents the flow of air along the walls of the monobloc active heat exchange element 438, and the arrow 468 this flow in the collector space 443 of the upper stage of the treatment chamber. The arrow 470, visible through the tear 472, made in the rear slope of the fleece 402₁, represents the downward flow of air in the inter-plate spaces 403. As regards the arrows 474, they represent the flows of air exiting from these inter-plate spaces 403 and entering the collector space 432 of the lower stage of the treatment chamber. The arrow 476 represents the flow of air which enters the bottom vent 426 of the chamber 401. The arrows 478, 479, 480 represent the flow of seawater to be distilled which enters, passes through and exits from the active heat exchange element 438.

By means of these arrangements, this still according to FIG. 13, with vapour diffusion and non-condensable heat-transfer gas, circulating by natural convection, operates under exactly the same conditions as the still in FIG. 6. Moreover, with the new model of plane, thin and flexible, hollow plate used, all the functional advantages of the heat exchanger monodistillation unit, according to the present invention, referenced 250 in FIG. 10A, are found improved. In fact, a set of hollow plates 400 possesses the same surface area of distillation heat exchange per unit volume, i.e. 400 m² per cubic metre, as a set of monobloc distillation exchangers, but in addition the thickness of the walls of these plates and of their hydrophilic coating is more than three times below that of these exchangers (0.15 instead of 0.50 mm). This considerably improves the Q/V ratio to be taken into account, in the calculation of the C_{IE} of the still, which then reaches the high value 297 indicated above. Moreover, if the production price of the main component of this new hollow-plates model 400, (namely the fine fleece 402, its suspension rod 404, its pressure bar 406 and its spacers 450) is compared to that of a large flexible plate 140 in FIG. 7 or even to the monobloc active element of a rigid distillation heat exchanger 250, in relation to the same exchange surface area, it is noted that this price is remarkably low (less than 1 ε, for a plate of 50 dm²) and several times lower than that of the two other models.

Moreover, it will be noted that it is relatively easy to avoid any swelling of the plane and tightened walls of the flexible and thin, hollow plates, 400, which can damage the efficiency of the still, by suitably choosing, on the one hand, the heights of the hollow plates and of the bottom and top vents of the still, and on the other hand, the thickness of these walls and their rigidity at the temperatures concerned as a function of the polymer used. This double choice has the objective of ensuring that the difference between the dynamic pressures of the rising flows of air in these hollow plates and downward flows in their inter-plate spaces, circulating in closed circuit, is practically negligible (of the order of 1 Pascal) before the mechanical pressure applied to the fleeces constituting the walls of these plates.

In order to improve the overall C_{OP} of such a still, it is useful to add to the distillation unit, formed by the hollow distillation plates 400₁₋₆, a unit for recovery of the heat of the hot distilled and concentrated liquids, produced by this still. This heat recovery unit comprises two groups of thin, hollow auxiliary plates, provided with hydrophilic coatings, installed vertically. The total surface area of the auxiliary plates of a heat recovery unit is approximately ten times less than that of the plates of the distillation unit with which it is associated. This ratio is an inverse function of the efficiency coefficient of the heat exchange carried out by these auxiliary plates. These auxiliary plates are rigid and suitable for supporting without deformation the hydrostatic pressures of the distilled and concentrated liquids which have to circulate in them. By way of example, these are rigid cellular panels of the type described above as a variant of the flexible panels 140₁₋₃ in FIG. 7, provided with coupling washers 172 and 174. These washers form feed duct sections, assembled by tie rods such as that referenced 186 in FIG. 8. The end 184 of the bottom feed duct of each group of auxiliary plates constitutes the inlet to this group, connected to the suction tube of a siphon, and the end of its top duct, the outlet from this group connected to the drainage tube of this siphon. The heat recovery unit formed by these two groups of auxiliary plates and by the tubes of their siphons are not shown, so as not to overburden the drawing and because these tubes are ordinary components, added to original components, described in detail and also shown. The hollow plates of this heat recovery unit have the same lengths and widths as the hollow plates of the distillation unit, and they also possess inter-plate spaces with lateral edges, made tight by spacers. These two units are attached and their components are stretched and clamped by rigid end panels, connected together by assembly tie rods.

Seawater, preferably at a temperature as low as possible (for example, cooled down by natural means or, by default, at T_{L1} rather than T_{L2}), is poured over the coatings of the two groups of hollow auxiliary plates and part of the flow of air at temperature T₄ circulates from the top downwards along these coatings. The two siphon suction tubes dip in the trough 416 for collecting the distilled water and in the reservoir 434 for collecting the concentrated salt water respectively and they are connected to the inlets to the two groups of plates of the heat recovery unit. The two drainage tubes of these siphons are connected to the outlets from these hollow auxiliary plates and one of these drainage tubes opens a good distance below the level of the trough 416, the other a good distance below the level of the reservoir 434. The hot liquids which circulate in these hollow auxiliary plates from the bottom upwards cause the evaporation on the one hand of some of the seawater poured over their coatings. The flows of cooled air which circulate along these coatings from the top downwards carry along the vapour thus produced and, on this occasion, heat up again and become saturated. The two flows of saturated hot air, which exit from the inter-plate spaces of these two groups of hollow heat recovery plates, are added to those which exit from the inter-plate spaces of the hollow distillation plates. The mixture is then reheated and supersaturated and it reaches the temperature T₁. Under these conditions, the temperatures of the distilled and concentrated liquids removed are relatively low, of the order of 40° C., i.e. 15° C. above the usual temperature T_{L1} of the liquid to be distilled. In the usual case where the quantities of distilled water and of salt water produced are equal, this has the result of causing the general C_{OP} of the still to increase to 20.

As a result of all that has just been said, a domestic solar still with saturated hot air circulating by natural convection which comprises (1) a solar boiler having 1 m² of solar collection unit, which produces 7 kWh thermal per day, (boiler 120′ in FIG. 6) installed in place of the heating tube 422 in FIG. 13, (2) a laminated distillation unit, formed from 100 flexible and plane, thin hollow plates (plates 400 with 20 dm² per face and a pitch of 4.5 mm) and (3) a heat recovery unit formed from some ten auxiliary hollow plates, can ensure a production of 200 litres of distilled water per day. With a small 35 kW gas burner, associated with one or more appropriate heating tubes 422, installed between two symmetrical sets of distillation and heat recovery units, each unit comprising 500 hollow distillation plates and 50 recovery plates, identical or similar to the plates 400 in FIG. 13 (each with 1 dm³ of active volume), a still can be constructed for small institutions which will have (with a C_{OP} of 20) a production of distilled water of approximately 20 m³ per day. An identical production of distilled water can be provided by a still provided, on the one hand, with a distillation unit of 2,000 tightened plane hollow plates, with 1 m² of surface area per face, a pitch of 4.5 mm and 10 m³ of total active volume and, on the other hand, with a solar boiler equipped with a solar collection unit of 100 square metres, producing approximately 700 kWh per day. With this last distillation unit, it is possible to construct a still, associated with an average 350 kW boiler, which produces approximately 200 m³/day. Such a boiler can be the heat exchanger for cooling the diesel engine of a small generating station or of a ship. A fresh-water production of a few thousand m³/day is possible with a still with saturated hot air, circulating by natural convection, comprising a boiler of a few tens of MW, feeding in parallel the heating tubes of several distillation units, with the total active volume of a few hundred cubic metres, provided with so many heat recovery units having a few tens of cubic metres of active volume.

The invention is not limited to the embodiments described.

The efficiency of the stills according to the invention results from the maximum use of the heat which is supplied to them, which requires, in advance, an optimum insulation of their treatment chamber. In the case of solar stills, necessarily installed in the open, such insulation is generally produced on site, by means of a local construction (in cobwork, for example). In this case, the external wall of the still is a panel which is not very thick, delimiting the relatively tight enclosure of the still.

In the case where the vapour-diffusion still with counter-current of water, according to FIG. 3, would not be able, for practical installation reasons, to operate by thermosiphon, a pump is used in order to ensure the circulation of the heat-transfer liquid.

The heat exchanger 80 constituted by the coaxial ducts 318 and 320 in FIG. 12B can be replaced by a simple monobloc heat exchanger 250 or 438.

The thin and flexible, plane hollow plates 400, with tightened walls, in FIG. 13, can clearly be used in order to constitute the distillation unit of a still according to FIG. 5.

In the case of a still with natural convection and a solar boiler, according to FIG. 6, provided with a reservoir 63′ for collecting the hot salt water, ensuring an additional night-time operation, only the distilled water produced will be the subject of a heat recovery.

In all the stills with heat-transfer gas circulating by natural convection, top and bottom vents of considerable height are necessary in order to engender this natural convection in a satisfactory manner and thus obtain an appropriate transit time t in the hollow distillation plates. Such heights can be inappropriate for a domestic still. But in this case, it is possible to correct this drawback by appreciably reducing these heights, whilst retaining the sought transit time t. This is done by installing, with a motor outside, the helix of a ventilator (identical to that 92 in FIG. 5), upstream of the inlets to the inter-plate spaces, in the unoccupied top space 443 of the still in FIG. 13. The thrust exerted by this helix on the flow of cooled air, which has just passed through the hollow distillation plates 400 and the inter-plate spaces of the monobloc heat exchanger 438 with losses of charge, compensates for these losses and propels this flow with an appropriate speed and pressure in the inter-plate spaces and thus increases the flow rate of the flow of air which circulates in closed circuit. By adjusting once for all the speed of rotation of this helix, it is possible to control the dynamic pressure of this flow of air in the inter-plate spaces, in order to prevent any deformation of the walls of the hollow plates, which would be detrimental to the satisfactory circulation of this flow of air in closed circuit.

Moreover, if it is desirable that such a domestic still could become a kitchen appliance, in the same way as a refrigerator, the heating tube 422 described in FIG. 13 and its feed (which is a device generally absent from kitchens) are advantageously replaced by a particular heat source, easy to constitute in the kitchen of an apartment or on a pleasure boat. And this heat source, which will moreover have an additional function as a means of propulsion, is constituted by a heating tube, producing vapour jets, installed as the tube 422. This tube will have a small internal diameter (2 cm, for example), it is closed at one end and provided with calibrated orifices, made at regular intervals (5 cm, for example) along a generating line. This tube is installed a good distance upstream of the inlets of the hollow plates, so that the vapour jets that it produces are, on the one hand, correctly directed and, on the other hand, capable of dispersing in the flow of gas before the latter enters the hollow plates. These vapour jets will, for example, have a temperature of 101° C. and a pressure just slightly higher (40 hPa) than atmospheric pressure. They are ejected at a speed of 110 m/s. And they will have a sufficient flow to be able to add 2 to 5° C., to temperature T₂ of the flow of air exiting from the inter-plate spaces, and thus saturate this flow of air while taking it to an optimum or simply efficient temperature T₁, at the inlet to the hollow plates. Moreover, these vapour jets will produce an upward thrust, additional to that engendered by natural convection and, if appropriate, to the downward thrust produced by the helix of a ventilator. It will be noted that such a heating tube with vapour jets can (as an additional heat source, operating whenever necessary) be installed upstream of the inlets to the hollow plates, when the still comprises a solar boiler such as that referenced 120′ in FIG. 6.

The vapour which will feed this heating tube with vapour jets is produced, completely safely, by a simple kettle connected to this tube by a heat-insulated tube. This kettle will contain distilled water and it is heated by any heating means available in the kitchen or, more generally, in the vicinity of the still. In the case where a production of distilled water is sought for a significant period (a few hours, for example), the kettle is a pot provided with a lid, suited to being fixed to it in tight manner. This lid will comprise a water intake and a vapour intake, intended to be connected by a tube to the free end of the tube with vapour jets. The water intake is extended by a duct, ending in a needle-valve closing device integral with a float (similar or equivalent to that 356-358 in FIGS. 11 and 12), in order for this pot to be able to operate at a constant level. And the water intake of this kettle is fed by a tube open to the open air (similar to the tube 113′ in FIG. 6), connected to the outlet trough from the still and provided with an overflow, opening above a reserve of distilled water. The quantity of distilled water thus consumed by the kettle, will reduce by one point the C_{OP} of the still. But this is scarcely significant, with a still according to the invention, such as that described in FIG. 13, which generally possesses a C_{OP} of at least 15. This solution can evidently also be used for stills for institutions, which are much more powerful, and this heating tube with vapour jets can then be used alone or associated with another heat source.

Such a domestic still, provided with both relatively short top and bottom vents, of a tube with calibrated orifices producing vapour jets and, if appropriate, with a ventilator, constitutes a domestic device of modest size, producing distilled water under advantageous economic conditions. Such a device is particularly well suited for equipping pleasure boats and kitchens in blocks of flats in certain large modern coastal towns (such as Hong Kong or Singapore), where there is continually a certain shortage of fresh water and where, in order to meet this chronic insufficiency, seawater is also distributed for flushing toilets.

When the temperature of the available water to be distilled is relatively high, above 35° C., for example, as is the case in certain deserts, the subsoil of which contain brackish water, it is necessary, in order for a vapour-diffusion still with counter-current of air to operate in optimum manner, to appreciably reduce this temperature before introducing it into the device. In order to do this, the large hollow rectangular plates 140, with hydrophilic coating, described in FIG. 7 will be used, converting it into a natural refrigerator. The liquid to be distilled will circulate by gravity inside these plates and, by gravity and capillarity, in their hydrophilic coating. By installing these plates in the shade, with a good distance between them, the dry air of the desert (or of any other arid region) will cause a continuous evaporation of a good part of the water which flows in the coating, which will have the effect of cooling down the water which circulates inside. The minimum temperature capable of being reached by such a natural refrigerator is the temperature of the dew point of the ambient air (i.e. below 10° C., for dry air).

As has been said in the PCT Application relating to the prior invention, the non-condensable gas, used in a vapour-diffusion still, cannot be pure air but a mixture of air and of a gas capable of completely eliminating the infectious germs that could be contained in the water to be distilled entering a vapour-diffusion still according to the present invention. In fact, measurements carried out in an official laboratory have proved that a distillation, carried out by means of such a still, could transform the polluted water resulting from lagooning treatment of the used water of an average town into potable water.

If the invention relates principally to methods and devices for producing fresh water from seawater, brackish water or polluted water, it is also of interest to the food and chemical industries, for producing concentrated liquids, such as syrups or brines. It is in fact particularly advantageous to recover the thermal energy from the hot effluents of the factories concerned, in order to economize on the considerable costs of evaporation of the different liquids to be concentrated.

1. Multiple-effect distillation method, intended for separating substances in solution from their liquid solvent, in particular for producing fresh water or concentrates, in which:
counter-current heat exchanges are carried out by a single liquid or gaseous heat-transfer fluid, circulating in closed circuit along surfaces, hot Sc and cold Sf respectively, linked by significant thermal conductance;
said surfaces Sc and Sf are faces of walls of thin distillation-heat-exchange hollow plates, installed in large numbers, vertical or inclined, in a heat-insulated treatment chamber, comprising narrow inter-plate spaces, of more or less constant width, filled with a non condensable gas, in particular air at atmospheric pressure; wherein:
the heat-transfer fluid circulates, in a first upward or downward direction, along the surfaces Sc, passing from a high initial temperature T1 to a final temperature T3 below T1, then in a second direction opposite the first, along the surfaces S_{f}, passing from an initial temperature T4, below T3, to a final temperature T2, above T4 and below T1;
at the top of the external faces of the walls of the hollow plates, inside which the heat transfer fluid circulates in said first direction, liquid to be distilled is poured which spreads out and runs down slowly in fine layers along these external faces;
under the action of the flow of heat-transfer fluid circulating in said first direction, some of the liquid to be distilled poured over said external faces evaporates, whilst this flow cools down, passing from T1 to T3, and the vapour produced diffuses in the non-condensable gas present in the inter-plate spaces;
under the action of the flow of heat-transfer fluid circulating in said second direction, the vapour diffused in the non-condensable gas condenses, whilst this flow heats up again, passing from T4 to T2, under the effect of a recovery of a significant part of the latent heat of condensation of the diffused vapour;
a heat source is arranged between the hottest ends of the surfaces Sc and Sf, in order to increase the temperature of the heat-transfer fluid from T2 to T1;
a cold source is arranged between the least hot ends of these surfaces Sc and Sf, in order to reduce the temperature of the heat-transfer fluid from T3 to T4;
a more or less constant local difference dH in enthalpy flows is established between the surfaces Sc and Sf, by giving appropriate amplitudes to the heat exchanges carried out between the flow of heat-transfer fluid and said hot and cold sources respectively;
the optimum temperatures of the heat-transfer fluid T1, T2 and T3, T4, at the ends of these same surfaces, are determined from the maximum Intrinsic Efficiency Criterion CIE=Q2/P.V of the installation, Q being the exchanged distillation thermal power, P being the thermal power provided by the heat source, and V the active volume of the installation.

2. Distillation method with vapour diffusion, according to claim 1, in which:
the heat-transfer fluid is the liquid to be distilled;
the thin, hollow distillation-heat-exchange plates are hot or cold and they are installed alternating in the heat-insulated treatment chamber, the internal faces of their respective walls constituting said hot Sc and cold surfaces Sf;
liquid to be distilled is poured over the external faces of the walls of the hot plates only; wherein:
the heat-transfer liquid circulates, in a first upward or downward direction, inside the hot plates, it enters very hot at temperature T1 and it exits cooled down to the temperature T3, having caused a partial evaporation of the liquid to be distilled flowing over the external faces of the walls of these hot plates;
at the outlet from these hot plates, the heat-transfer liquid at temperature T3 is cooled down to temperature T4;
then, the heat-transfer liquid at temperature T4 enters inside the cold plates where it circulates in a second direction, opposite the first, causing, on the external faces of the walls of these cold plates, a condensation of the vapour diffused through the layer of non-condensable gas in the inter-plate space and recovering some of the condensation heat from this vapour in order to be heated up again, and finally it exits from the cold plates at temperature T2;
during these operations, the flow of heat passes through the walls of the hot and cold hollow plates as well as the immobile layers of non-condensable gas which separate them;
the distilled liquid runs down along the external faces of the walls of the cold plates whilst the concentrated liquid runs down along the external faces of the walls of the hot plates;
the optimum temperature T1 of the heat-transfer liquid, at the inlet to the hot hollow plates, is as little as possible below the boiling temperature of this liquid at atmospheric pressure;
the optimum temperature T3 of the heat-transfer liquid, at the outlet from the hot hollow plates, is relatively high and situated in a range which corresponds to a zone surrounding the maximum Intrinsic Efficiency Criterion C_{IE} of the installation;
the differences in temperature (T1−T2) and (T3−T4) are small, with (T1−T2) being slightly greater than (T3−T4).

3. Distillation method with vapour diffusion and heat-transfer liquid, according to claim 2, wherein:
the correspondence between the optimum range of the temperatures T3 and the maximum CIE, is achieved by means of their respective relationships with a composite variable t.dT, in which t is the transit time of the heat-transfer liquid in the plates and dT the difference in temperature between the liquids circulating in the cold and hot hollow plates;
the optimum difference in temperature dT is established by an adjustment of the ratio between the heating power of the heat source and the mass flow rate D of circulating heat transfer liquid;
the optimum value chosen for dT is relatively high when the unit cost of the thermal energy easily available at the site of implementation of the method is relatively low;
the useful range of the temperature T3 is the range from 58 to 78° C., when the liquid to be distilled is water;
the optimum transit time t of the heat-transfer fluid in the heat-exchange plates is established by adjustment of the mass flow rate D of the heat-transfer liquid circulating in a closed loop.

4. Distillation method with vapour diffusion and heat-transfer liquid, according to claim 3, in which the heat-transfer liquid circulates, by thermosiphon or by pumping, from the top downwards inside the hot hollow plates and from the bottom upwards inside the cold hollow plates, wherein:
a heat exchange for heating is carried out between the flow d of liquid to be distilled entering the installation at temperature TL1 and the two flows of distilled and concentrated liquids leaving it, so as to take the temperature of this flow d to a relatively high optimum intermediate value TL2;
mixing is carried out between this entering flow d thus heated and the flow D of heat transfer liquid exiting from the hot plates at temperature T3, the ratio d/D being adjusted so that the mixture thus produced is at an optimum temperature T4 at the inlet to the cold plates.

5. Distillation method with vapour diffusion and heat-transfer liquid, according to claim 3, wherein:
the heat-transfer liquid circulates by thermosiphon, from the bottom upwards inside the hot hollow plates and from the top downwards inside the cold hollow plates;
the flow d of liquid to be distilled entering at temperature TL1 is added to the flow D of heat transfer liquid exiting at the temperature T3 of the hot plates, the ratio d/D being adjusted so that the mixture thus produced is at an optimum temperature T4 at the inlet to the cold plates;
a flow d of liquid at temperature T3 or T4 is poured over the top of the external faces of the hot plates.

6. Distillation method with vapour diffusion, according to claim 1, in which:
the heat-transfer fluid is said non-condensable gas, saturated with vapour of the liquid to be distilled;
liquid to be distilled is poured over the top of the external faces of the walls of all the distillation-heat-exchange hollow plates, these external faces constituting said cold surfaces Sf whilst the internal faces of the walls of these plates constitute said hot surfaces Sc; wherein:
the flow of heat-transfer gas at temperature T1 enters inside all the hollow distillation plates, where it circulates in a first upward or downward direction, whilst some of its vapour condenses on the internal faces of the walls of the plates, flows of heat, resulting from a virtually total recovery of the latent heat of condensation, pass through the walls of the plates in order to evaporate some of the liquid flowing over the external faces of these walls and, as a result, this flow of gas cools down and finally exits from the hollow plates at temperature T3;
at the outlet from these plates, this flow of heat-transfer gas at temperature T3 is cooled down to temperature T4 by heat exchange and the distilled liquid, condensed on this occasion, is recovered;
then, this flow of heat-transfer gas, at temperature T4, enters the inter-plate spaces, where it circulates in a second direction, the reverse of the first, carrying away the vapour produced in these spaces and reheating it, and finally it exits from these spaces at temperature T2;
the distilled liquid, condensed on the internal faces of the walls of the hollow plates, runs down along these internal faces whilst the concentrated liquid runs down along the external faces of these walls;
the optimum temperature T1 of the flow of heat-transfer gas, at the inlet to the hollow plates, is situated within a wide range surrounding the maximum Intrinsic Efficiency Criterion C_{IE} of the installation;
the temperature T4 of the flow of heat-transfer gas, at the inlet to the interpolate spaces, is optimum when, by appropriate cooling, it is made as close as possible to the minimum temperature of the natural cold source available at the site;
the difference in temperature (T1−T2) is small and the difference (T3−T4), considerable.

7. Distillation method with vapour diffusion and heat-transfer gas, according to claim 6, wherein:
the correspondence between the optimum range of the temperatures T1 and the maximum C_{IE} zone is achieved by means of their respective relationships with a composite variable t.dH/V, in which t is the transit time of the heat-transfer gas in the hollow plates and dH a more or less constant local difference in enthalpy flows between the internal and external faces of the walls of the hollow plates;
the useful range of the temperature T1 is approximately comprised between 74 and 91° C.;
the optimum local difference in enthalpy flows dH, between the internal and external faces of the walls of the hollow plates, is established by adjustment of the ratio between the heating power of the heat source and the circulating mass flow rate D of the heat-transfer gas;
the optimum value of the difference dH is higher when the CIE and the cost of the thermal energy easily available on site are relatively low;
the optimum transit time t of the flow of heat-transfer gas in the hollow plates is established by adjustment of the mass flow D of this flow of gas.

8. Distillation method with vapour diffusion and heat-transfer gas, according to claim 7, wherein, according to a first set of arrangements,
the flow of gas at temperature T1 is introduced at the top of the hollow distillation plates and it exits at the bottom at temperature T3;
at the outlet from the hollow distillation plates, this flow of gas at temperature T3 is subjected to a first cooling-down heat exchange, ensured by a cold source at temperature TL1, constituted by the entering flow of liquid to be distilled, in order that, given the respective mass and thermal characteristics of this flow of gas and of this flow of liquid, the temperature T3 of the flow of gas is reduced to an optimum temperature T4 and the temperature of the liquid taken to TL2;
after this heat exchange, the liquid to be distilled at temperature TL2 is reheated by a heat source;
the flow of gas at temperature T4 is introduced at the bottom of the inter-plate spaces and it exits at the top at temperature T2;
the flow of gas circulates in closed circuit in the hollow plates and in the inter-plate spaces, under the action of at least one means of propulsion;
at the outlet from the inter-plate spaces, the flow of gas at temperature T2 is reheated and saturated with vapour, by an appropriate physical contact with the liquid to be distilled reheated by the heat source, so as to take on an optimum or simply effective temperature T1;
after its physical contact with the flow of gas at temperature T2, the liquid to be distilled is poured, at a temperature of approximately T1, over the top of the external faces of the walls of the hollow plates, and it exits at a temperature of approximately T4;
the distilled liquid, condensed during said cooling-down heat exchange, and that condensed on the internal faces of the hollow plates, are collected, then removed and recovered;
the concentrated liquid is collected at the bottom of the external faces of the walls of these plates, then it is removed and, if appropriate, recovered.

9. Distillation method with vapour diffusion and heat-transfer gas, according to claim 8, wherein:
said hollow distillation plates forming a large number N of plates, a small flow of heat transfer gas at temperature T1 is introduced into a small number n of hollow auxiliary reheating plates, in order to participate in a second heat exchange, intended to reheat the liquid to be distilled exiting from a third heat exchange;
the flow of liquid to be distilled which exits reheated from this second heat exchange is introduced into the heating chamber of the boiler, in place of that exiting previously from the first heat exchange;
on exiting from these n hollow reheating plates, the small cooled-down flow of heat transfer gas is mixed with the flow of heat-transfer gas exiting from the N hollow distillation plates, then the mixture is subjected to said first heat exchange, in order to exit from it at said temperature T4;
the liquid to be distilled exiting from the first heat exchange is reheated, during said third heat exchange, by the distilled liquid which has condensed on the internal faces of the walls of the (N+n) plates;
the flow rates of distilled liquids, produced at the outlet from these (N+n) hollow plates and during the first heat exchange, are mixed then removed and recovered.

10. Distillation method according to claim 9, wherein:
the heat source is a boiler provided with a heating chamber operating at a constant level of liquid and suited to producing very hot liquid and vapour jets;
the very hot liquid to be distilled is spread over a support, in order to be swept by the flow of heat-transfer gas at temperature T2;
the vapour jets constitute means of propulsion intended to cause the flow of heat transfer gas to circulate in closed circuit and in the opposite direction to natural convection, and, moreover, to reheat and supersaturate this flow in order to take it to an optimum or simply effective temperature T1;
the heating power of the boiler is variable and the flow rates of hot liquid and of vapour are controlled by adjusting this power.

11. Distillation method with vapour diffusion and heat-transfer gas, according to claim 7, wherein, according to a second set of arrangements,
the flow of saturated gas at temperature T1 is introduced at the bottom of the hollow distillation plates and it exits at the top at temperature T3;
at the outlet from the hollow distillation plates, this flow of gas is subjected to a cooling-down heat exchange, ensured by a cold source at temperature TL1, constituted by the entering flow of liquid to be distilled, so that, given the mass and thermal characteristics of this flow of gas and of this flow of liquid, the temperature T3 of the flow of gas is reduced to an optimum temperature T4 and the temperature of the liquid taken to TL2;
after this heat exchange, the liquid to be distilled at temperature TL1 or TL2 is poured over the top of the external faces of the walls of the hollow plates, it runs down along these external faces and leaves them at a temperature of approximately T2;
the flow of gas, at temperature T4, is introduced at the top of the inter-plate spaces and it exits at the bottom at temperature T2;
at the outlet from the inter-plate spaces, the flow of gas at temperature T2 is subjected to the action of a heat source, in order to be reheated and saturated with vapour, and taken to an optimum or simply effective temperature T1;
the flow of gas at temperature T1 is introduced at the bottom of the hollow plates and, at least by natural convection, it rises inside these plates, then it exits at the top, it then passes through a zone where it undergoes said cooling-down heat exchange then, at temperature T4, it enters and runs down by gravity in the inter-plate spaces;
the distilled liquid, condensed during the cooling-down heat exchange and that condensed along the internal faces of the walls of the hollow plates are collected, then removed;
the concentrated liquid is collected at the bottom of the inter-plate spaces with a view to immediate or subsequent removal.

12. Distillation method according to claim 11, wherein,
on exiting from the inter-plate spaces, the concentrated liquid is reheated by a heat source;
the flow of gas exiting from these inter-plate spaces is reheated and saturated by appropriate physical contact with the concentrated liquid, reheated by this heat source;
the slightly more concentrated liquid which results from the preceding operation is, if appropriate, collected in a reservoir, from where it is removed periodically.

13. Distillation method according to claim 11, wherein:
before being removed in continuous manner, the distilled liquid collected circulates from the bottom to the top in a small group of hollow auxiliary heat recovery plates, separated by narrow inter-plate spaces;
if appropriate, the same applies to the condensed liquid collected;
these hollow auxiliary heat recovery plates are at the same time rigid, thin and provided with external, hydrophilic or wettable coatings;
liquid to be distilled, preferably as cold as possible, is poured over the top of these coatings;
a part of the flow of gas at temperature T4 circulates from the top downwards along these thus moistened coatings;
the flow of saturated hot gas which leaves these coatings is added to that which exits from the inter-plate spaces of the hollow distillation plates, then the mixture is reheated and saturated in order to reach an effective or optimum temperature T1;
the distilled and concentrated liquids exit cooled down again at the top of these hollow auxiliary heat recovery plates then they are removed and at least one of them is recovered.

14. Distillation method according to claim 12, wherein:
the heat source concerned is a solar boiler, suited to heating a thin hydrophilic mat, inclined as a function of the latitude of the installation site;
the concentrated hot liquid which flows from the inter-plate spaces, ends up in a trough into which the top part of this hydrophilic mat is dipped;
the concentrated hot liquid which flows from this hydrophilic mat is collected in a heat insulated reservoir, the surface of which is both uncovered and also as wide as possible and the depth sufficient for it to be able to contain the concentrated liquid produced during one day;
the flow of gas, which exits from the inter-plate spaces, is directed towards the surface of the hot liquid contained in this reservoir, in order to sweep across it and thus benefit from preheating;
then, the flow of gas thus preheated sweeps over this hydrophilic mat, heated during the day and constantly moistened by the concentrated liquid, in order to be reheated and saturated, before entering the bottom of the hollow distillation plates;
the reservoir is emptied every morning, so that a limited additional distillation can be carried out during the night.

15. Distillation method according to claim 12, wherein the heat source concerned is a heating tube provided with a hydrophilic coating with clear slopes, over which is poured the concentrated liquid which flows from the inter-plate spaces, the very concentrated liquid produced being removed continuously.

16. Distillation method according to claim 11, wherein:
the heat source concerned is constituted by vapour jets, installed at a good distance and orientation, upstream of the inlets to the hollow plates;
these vapour jets reheat and saturate the flow of gas exiting from the interpolate spaces and, moreover, they constitute auxiliary means of propulsion which increase the speed of circulation by natural convection of this flow and can thus give an optimum value to the transit time of this flow of gas in the hollow plates;
the concentrated liquid exiting from the inter-plate spaces is collected and removed continuously.

17. Distillation method according to claim 16, wherein a ventilator is used just upstream of the inter-plate spaces, in order to increase the circulating flow.

18-20. (canceled)

21. Still with vapour diffusion and heat-transfer gas, in particular for producing fresh water or concentrates, according to the distillation method of claim 8 comprising:
a distillation unit, constituted by a large number N of thin hollow plates, large and separate or small and integral, and by narrow inter-plate spaces, filled with a non-condensable gas, in particular air at atmospheric pressure, constituting said heat transfer gas;
means of propulsion for causing the saturated heat-transfer gas to circulate, in closed circuit, from the top downwards inside the hollow plates and from the bottom upwards in their inter plate spaces;
means for pouring the hot liquid to be distilled over the top of the plates;
means for collecting the distilled liquid, condensed on the internal faces of the plates, and means for collecting the condensed liquid which flows along their external faces;
a heat source, arranged between the top ends of the plates and of the inter-plate spaces, and a cold source, arranged between their bottom ends; wherein:
the heat source is installed just above the plates, in the middle of the flow of heat transfer gas exiting from the inter-plate spaces in order to enter inside the hollow plates, in order to take the temperatures of this flow to T2 and T1 and, on this occasion, to supersaturate it in vapour;
this heat source comprises a tray, if appropriate covered with a spongy mat, provided with a base perforated with small holes, associated with ducts and/or distribution wicks, this tray being installed under one or more tubes for extraction of the hot liquid to be distilled present in the heating chamber of a boiler;
the cold source is constituted by a first heat exchanger comprising an active element, enclosed in a casing;
the inlet of this active element is connected to a reservoir of cold liquid to be distilled, if appropriate, through an auxiliary device with natural cooling, and its outlet, connected by appropriate means to the inlet to the heating chamber of the boiler;
the inlet of the casing is connected to the outlet from the N separate or integral hollow plates, and its outlet to the inlet to the inter-plate spaces;
the means of propulsion are constituted by a ventilator, installed upstream of the inlets to the inter-plate spaces, and/or by vapour jet, engendered upstream of the inlets to the hollow plates;
the casing comprises a duct for removal of the distilled water produced, which cooperates with the means intended for collecting that which flows from the bottom of the N hollow plates.

22. Still with vapour diffusion and heat-transfer gas, according to claim 21, wherein:
a small number n of hollow auxiliary plates is installed in the vicinity of the N hollow plates of the distillation unit, in order to constitute a second heat exchanger with counter-current operation, between a small part of heat-transfer gas, saturated at temperature T1 and the flow of liquid to be distilled which exits from a third heat exchanger, arranged between the outlet from the first heat exchanger and the means for collecting distilled liquids which flow over the internal faces of the walls of the (N+n) hollow plates;
the N hollow plates of the distillation unit and the n auxiliary plates open into a duct with a common outlet, connected to the casing of the first heat exchanger;
the distilled liquid which exits from the n auxiliary plates is added to those which exit from the N distillation plates and from the casing of the heat exchanger.

23-37. (canceled)
